(19) United States
(12) Patent Application Publication
(10) Pub. No.: US 2015/0316945 A1
(43) Pub. Date: Nov. 5, 2015

(54) CONFIGURABLE WEB-BASED METERING OF BUILDING ENERGY USING WIRELESS SENSORS

(71) Applicant: AQUICORE, INC., Washington, DC (US)

(72) Inventor: Logan SOYA, Arlington, VA (US)

(73) Assignee: Aquicore, Inc., Washington, DC (US)

(21) Appl. No.: 14/449,893

(22) Filed: Aug. 1, 2014

Related U.S. Application Data
(60) Provisional application No. 61/987,953, filed on May 2, 2014.

(51) Int. Cl. G05F 1/66; H04L 29/08; G05B 15/02

(52) U.S. Cl. CPC G05F 1/66; G05B 15/02; H04L 67/10

(57) ABSTRACT

Embodiments relate to providing a configurable energy management service to remote users of computing devices over a computer network. A computer-implemented method is provided for enabling a user to configure energy management of at least one building or project from a remote computing device through an energy management service hosted on a computer network. The method includes hosting a set of energy management modules configurable for different users subscribed to the energy management service, and storing in a database energy management information relating to a building or project fitted with wireless sensors that capture data representative of real-time power consumption. Other embodiments are a system and non-transitory computer readable medium for enabling a user to configure energy management of at least one building or project from a remote computing device through an energy management service hosted on a computer network.

### CROSS-REFERENCE TO RELATED APPLICATIONS

This application is a U.S. Nonprovisional Application which claims the benefit of U.S. Provisional Application No. 61/987,953 filed on May 2, 2014, which is incorporated herein by reference in its entirety.

### BACKGROUND OF THE INVENTION

### Background Art

Many buildings and projects consume electrical energy in their operation. Managers of buildings and projects have monitored electrical energy consumption with meters that sense voltage or current. One type of meter senses total current of a building and is used to generate monthly bills based on total power usage over a period of time and/or a peak amount of power usage within the period of time. Such metering of total building current alone and monthly reporting however does not provide a real-time measure of power usage at different time intervals or by different components within a building. Moreover, building managers do not have remote access to real-time power usage information. Managers are often limited to visibly observing meter operation on site which may be physically inconvenient when located in basements or fixed locations. Inspection of current meters at a particular time also does not provide information sufficient to manage building energy usage over a time period as the building operates. Inspection of current meters also does not allow building managers to assess real-time power usage by different components within a building at the same time. Even if additional meters are provided to support sub-metering, visible inspection of different current meters is time-consuming and also does not provide information sufficient to manage and optimize building energy usage over a time period as the building operates.

Some buildings have local network solutions with onsite servers installed to process data sent from current meters in the buildings over cabling to the onsite servers. Reports are then generated on enterprise applications installed on computers at the building. Installing such local network solutions and enterprise applications, and operating onsite servers however is cost-prohibitive for many building owners.

### BRIEF SUMMARY OF THE INVENTION

Embodiments of the present disclosure relate to providing a configurable energy management service to remote users of computing devices over a computer network. Users can subscribe to different energy management modules hosted by the configurable energy management service and access them through a subscription manager. Buildings or projects are fitted with sensors that sense voltage and current data for communication over a computer network to the configurable energy management service.

In one embodiment, a computer-implemented method is provided for enabling a user to configure energy management of at least one building or project from a remote computing device through an energy management service hosted on a computer network. The method includes hosting a set of energy management modules configurable for different users subscribed to the energy management service, and storing in a database energy management information relating to a building or project fitted with wireless sensors that capture data representative of real-time power consumption. The method further includes steps of receiving a request from a remote user to access the energy management service, determining one or more of the energy management modules in the set in accordance with a subscriber profile associated with the remote user, and enabling the remote user to access energy management information that relates to a building or project. The remote user can access the energy management information from a remote computing device through the energy management service hosted on the computer network using the determined one or more energy management modules.

In one feature, the determined one or more energy management modules includes one or more of a building optimization module, portfolio benchmarking module, project tracking module, energy star compliance module, and/or tenant billing module.

In a further feature, a building optimization module has a real-time energy optimization tool, and the enabling includes providing a real-time energy optimization tool for display to the remote user on the remote computing device. In one embodiment, the real-time optimization tool is configured to provide a graphical display of real-time power usage over a predetermined time period for the building based on the stored energy management information in the database. In one feature, the graphical display of real-time power usage over a predetermined time period for the building comprises a candlestick graph that illustrates points of peak energy consumption along with regions of maximum and minimum average energy consumption. Other features of the real-time optimization tool can include providing a user-interface element for a user to enter annotations, providing a graphical display of statistical data on energy usage by the building based on the stored energy management information in the database, and/or providing a user-interface element that enables the remote user to select management, technical, scheduling, weather, or trend operations.

In a further feature, a portfolio benchmarking module has a real-time energy optimization tool configured to provide a user interface element that allows the remote user at the remote computing device to obtain real-time portfolio status and performance information on the energy usage of a portfolio of buildings.

In a still further feature, a compliance benchmarking module has a real-time energy optimization tool configured to provide a user interface element that allows the remote user at the remote computing device to automatically generate a compliance submission for a building and/or view and track an energy rating and metrics for a building.

In one example at initialization, the method includes steps of enabling the remote user to select one or more energy management modules for a subscription service, identify a number of buildings or projects fitted with the wireless sensors that correspond to meters and sub-meters to be included in the subscription service, and create a subscriber profile for the remote user corresponding to the selected subscription service.

In another embodiment, a system is provided for enabling a user to configure energy management of at least one building or project from a remote computing device through an energy management service hosted on a computer network. The system includes a subscription manager implemented on a host computing device that hosts a set of energy management modules configurable for different users subscribed to the energy management service, and a database, coupled to the host computing device, that stores energy management information relating to a building or project fitted with wireless sensors that capture data representative of real-time power consumption.

The subscription manager is configured to receive a request from a remote user to access the energy management service, determine one or more of the energy management modules in the set in accordance with a subscriber profile associated with the remote user, and enable the remote user to access energy management information relating to a building or project from the remote computing device through the energy management service hosted on the computer network using the determined one or more energy management modules.

In another embodiment, a non-transitory computer-readable medium is provided, having instructions stored thereon, that when executed by at least one processor, cause the at least one processor to perform operations for enabling a user to configure energy management of at least one building or project from a remote computing device through an energy management service hosted on a computer network. The operations include hosting a set of energy management modules configurable for different users subscribed to the energy management service, and accessing a database having stored energy management information relating to a building or project fitted with wireless sensors that capture data representative of real-time power consumption. Further operations include receiving a request from a remote user to access the energy management service, determining one or more of the energy management modules in the set in accordance with a subscriber profile associated with the remote user, and enabling the remote user to access energy management information relating to a building or project from the remote computing device through the energy management service hosted on the computer network using the determined one or more energy management modules.

Further embodiments, features, and advantages of this invention, as well as the structure and operation and various embodiments of the invention, are described in detail below with reference to accompanying drawings.

### BRIEF DESCRIPTION OF THE DRAWINGS/FIGURES

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1A is a diagram illustrating an example system for configurable building energy management using wireless sensors, according to an embodiment.

FIG. 1B provides a flowchart illustrating an example method for enabling a user to configure energy management of at least one building or project from a remote computing device through an energy management service hosted on a computer network.

FIG. 2A provides a flowchart illustrating an example configuration method for a user to select and subscribe to one or more energy management modules.

FIG. 2B is a flowchart illustrating an example method for a user to configure sub-metering energy management.

FIG. 3 provides an overview of a set of energy management modules hosted by energy management service.

FIG. 4 provides a flowchart illustrating an example method for the subscription manager to pre-process raw energy data received from metering sensors and sub-metering sensors.

FIG. 5 is a flowchart illustrating an example method for a user to access energy management service based a subscribed energy management module.

FIG. 6A illustrates an interface provided by a building optimization module that helps a user to take real-time connective actions.

FIG. 6B illustrates another interface provided by a building optimization module that helps a user to take real-time corrective actions.

FIG. 6C illustrates another interface provided by a building optimization module that breaks down energy usage and cost.

FIG. 7A illustrates an interface provided by a portfolio benchmarking module.

FIG. 8A illustrates an interface provided by a energy star compliance module.

FIG. 9A illustrates an interface provided by a tenant billing module for meter reading.

FIG. 9B illustrates another interface provided by a tenant billing module that shows a more detailed and informative invoicing.

FIG. 10A illustrates an interface provided by a project tracking module for a quick portfolio report.

FIG. 10B illustrates another interface provided by a project tracking module for a monthly progress report.

FIG. 10C illustrates another interface provided by a project tracking module for a client and executive ready report.

FIG. 11A illustrates an interface provided by a property information management module displaying basic information about a selected building.

FIG. 11B illustrates another interface provided by a property information management module for inventory information.

FIG. 11C illustrates another interface provided by a property information management module for real-time tracking of circuits.

FIG. 12 is a flowchart illustrating another example method for the subscription manager to pre-process raw energy data received from the wireless sensors.

FIG. 13A is a flowchart illustrating an example method for the subscription manager to process a request to access partitioned energy management information.

FIG. 13B provides example data structures of requests and responses for the user to access energy management service.

FIG. 14A is a flowchart illustrating an example method for automatically choosing an optimized time interval for a display prepared by an energy management module.

FIG. 14B provides an example of a candlestick graph for displaying energy data.

FIG. 15 provides an example relational data structure that represents electrical infrastructure of a building.

FIG. 16 is a block diagram of an exemplary electronic device where embodiments may be implemented.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

Embodiments of the present disclosure relate to providing a configurable energy management service to remote users of computing devices over a computer network. Users can subscribe to different energy management modules hosted by the configurable energy management service and access them through a subscription manager. Buildings or projects are fitted with sensors that sense voltage and current data for communication over a computer network to the configurable energy management service.

In one feature not intended to be limiting, building or projects are fitted with wireless sensors that communicate data over a computer network to an energy management service, such as a cloud computing web-based service operated over the Internet, that can be accessed by remote users through a subscription manager. According to one advantage building or projects fitted with wireless sensors that communicate data over a computer network to an energy management service can be installed at a relatively inexpensive cost. Expensive enterprise applications installed onsite servers for energy management can be avoided. Energy management information can also be accessed more flexibly from different locations by managers through remote computing devices such as mobile tablet and smart phone devices. Such remote computing devices can be coupled to a cloud computing web-based service operated over the Internet that can be accessed by remote users through a subscription manager. The subscription manager can further provide more scalable, flexible options on the type of energy management information and capabilities provided more tailored to a particular subscriber needs.

### I. Configurable Energy Management

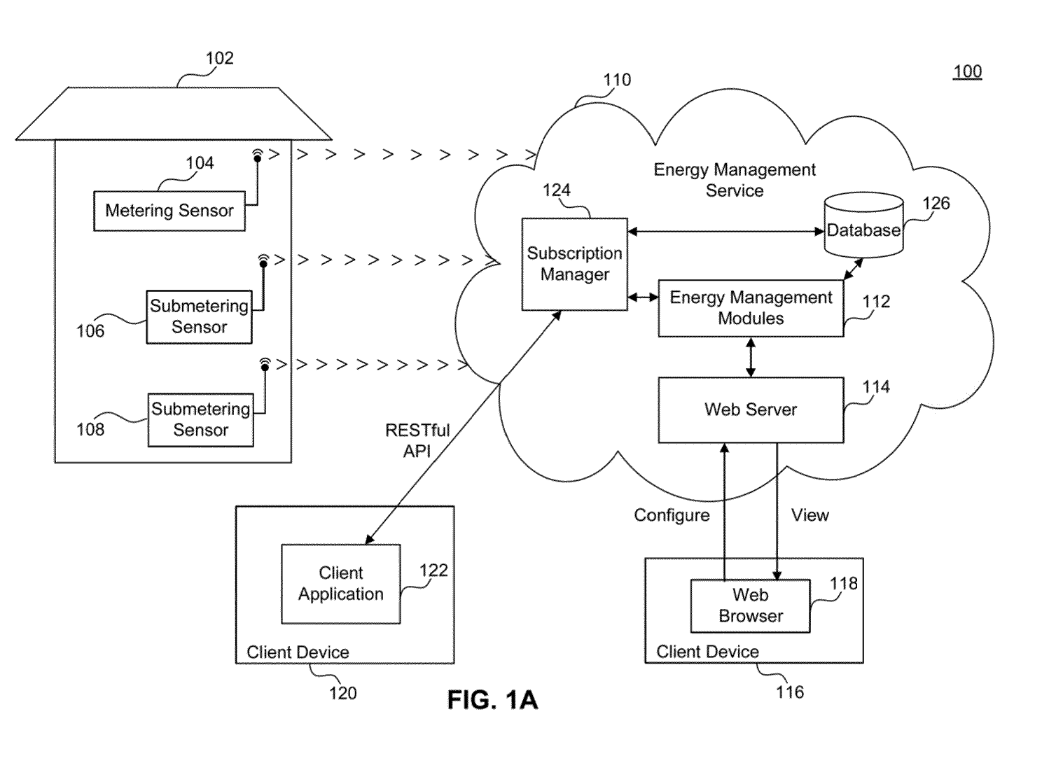

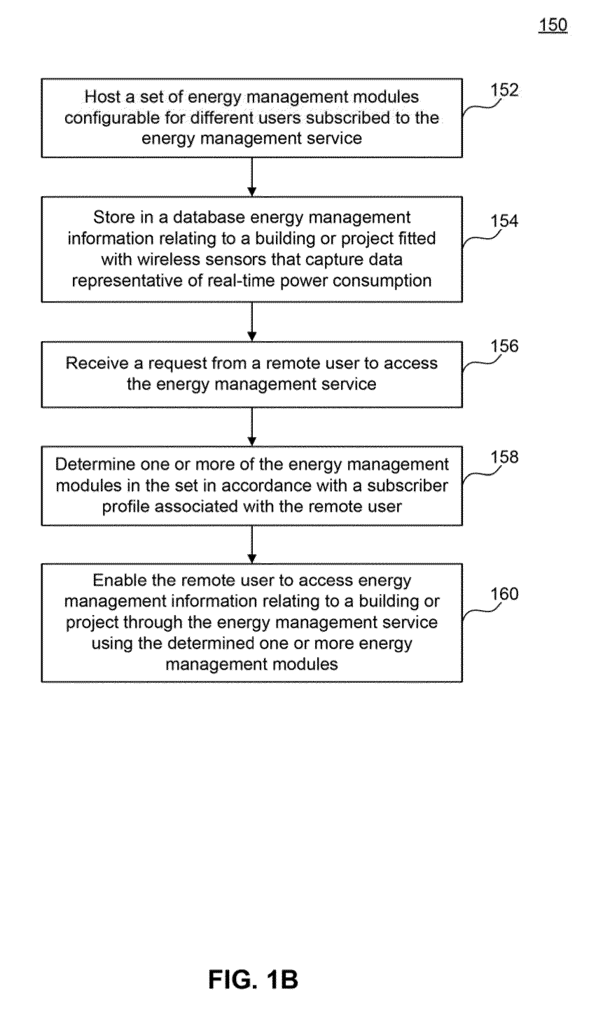

FIG. 1A is a diagram illustrating an example system 100 for configurable building energy management using wireless sensors, according to an embodiment. System 100 includes energy management service 110, sensors in building 102, and client devices 116 and 120. When a user decides to access energy management service 110 to manage energy usage of building 102, the user may install sensors in building 102. Installed sensors may be any commercial off-the-shelf energy meters with network connectivity. These installed sensors can measure and capture data related to energy usage. For example, some sensors can measure voltage or current of a device or a building. In a feature, sensors can be located at a common location to measure voltage and current of a device or a building allowing true power, which a function of voltage times current, to be determined in real-time. In another feature, separate sensors can be located at different locations to measure voltage and current of a device or a building. Data from the sensors is sampled at periodic time intervals that still allows true power to be determined in real-time. In one example such sampling of the data sensed for voltage and current can be carried out on the order of seconds, milliseconds or less depending upon available computing power so that true power consumption of a device or a building can be obtained in real-time. In one embodiment, energy management service 110 is remote to building 102, and installed sensors in building 102 send measured raw energy data in wireless signals to management service 110 via wireless connections. In another example, sensors may send the data to an internal device within the building over wired or wireless connections which in turns transmits the data to energy management service 110.

The sensors installed in building 102 may be for building level metering. For example, metering sensor 104 is for measuring building-level energy usage of building 102. The user can also install sub-metersub-metering sensors. Sub-metersub-metering may provide measurement at the tenant level. For example, sub-metering sensor 106 may be installed to measure energy usage of a particular tenant. Sub-metering may also provide energy measurement at the equipment level. For example, sub-metering sensor 108 may be installed to measure energy usage of a particular electrical device.

Since energy management service 110, remote to building 102, performs processing of measured raw energy data received from the sensors, the user does not need to install additional on-site servers in building 102. Similarly, besides transmission of measured raw energy data from the sensors to energy management service 110, no additional integration work is needed for the hardware installation. The simplified and flexible installation of sensors in building 102 illustrates a universal hardware deployment scheme of system 100, with which one installation solution satisfies different needs of different users, regardless of the managed buildings' age, size, or energy system.

Energy management service 110 provides a centralized platform for managing energy usage. Energy management service 110 helps users of the service to make fast cost-saving decisions, centralize oversight, improve staff productivity, track project return on investment (ROI), and enhance tenant satisfaction. Energy management service 110 includes multiple components interworking with each other. One or more components of energy management service 110 can be implemented in software, firmware, hardware, or any combination thereof. Depending upon the particular implementation, the components of energy management service 110 can be implemented on the same or different server devices and can be made to operate with a variety of applications. Further, the components of energy management service 110 may be implemented on a distributed computing system. In an example embodiment, energy management service 110 may include architecture distributed over one or more networks, such as, for example, a cloud computing architecture. Cloud computing includes but is not limited to distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), API as a service (APIaaS), integration platform as a service (IPaaS), etc.

Energy management service 110 hosts a set of energy management software modules 112. Energy management software modules 112 are configurable for different users subscribed to the energy management service. Based on the user configuration, a user may subscribe to one or more of the set of energy management modules including, but not limited to, a building optimization module, portfolio benchmarking module, project tracking module, energy star compliance module, tenant billing module, and public engagement module.

Energy management service 110 includes subscription manager 124. Subscription manager 124 coordinates activities of different components within energy management service 110. For example, subscription manager 124 may receive a user configuration of energy management module selection. Subscription manager 124 then generates a user subscriber profile based on the user configuration and stored the generated profile in database 126. Later, when a user tries to access energy management service 110, subscription manager 124 may determine which energy management modules hosted in energy management service 110 are available to the user. Further, subscription manager 124 may receive wireless signals from installed sensors in building 102 and extract measured raw energy data from the wireless signals. Subscription manager 124 may also pre-process the received raw energy data and store the pre-processed energy data into database 126.

Energy management service 110 includes database 126. Database 126 may store raw energy data received from metering sensor 104 and sub-metering sensors 106 and 1 08. Database 126 may be a database platform rumling database management software available from an organization such as a commercial vendor or open source community. Various database platforms may include, but are not limited to, Oracle, Sybase, Microsoft SQL Server, MySQL, PostgreSQL, IBM DB2, Informix, and SQLite.

Energy management service 110 includes web server 114. Web server 114 may be configured to accept requests for resources from client devices, such as web pages and send responses back to client devices. Any type of web server may be used including, but not limited to, Apache available from the Apache Project, IIS available from Microsoft Corp., nginx available from NGINX Inc., GWS available from Google Inc., or other type of proprietary or open source web server. Web server 114 may also interact with energy management modules 112 and subscription manager 124. In an example embodiment, energy management modules 112 provide energy management information, such as energy data or charts, to web server 114 to present to the user who accesses a subscribed energy management module through web browser 118. In another example embodiment, web server 114 may consult with subscription manager 124 to determine which energy management module the user has subscribed and thus is available to the user.

A user can use client devices 116 and 120 to configure and access services provided by energy management modules 112. Example client devices include, but are not limited to, any type of processing device including, but not limited to, a computer, workstation, distributed computing system, embedded system, stand-alone electronic device, networked device, mobile device (such as a smartphone, tablet computer, or laptop computer), set-top box, television, or other type of processor or computer system.

Client device 116 includes web browser 118. Any type of browser may be used including, but not limited to, Internet Explorer available from Microsoft Corp., Safari available from Apple Corp., Chrome browser from Google Inc., Firefox, Opera, or other type of proprietary or open source browser. A browser is configured to request and retrieve resources, such as web pages that provide options to configure subscription of energy management modules, and present energy data and graphs/charts viewed by the user.

When the user knows what energy management modules to subscribe, the user may use web browser 118 to configure and select one or more modules from energy management modules 112. The configuration of the user's subscription of energy management modules may be transmitted to web server 114. In one example, the request is transmitted as a hypertext transfer protocol (HTTP) request. Web server 114 then forwards the configuration data to subscription manager 124, and subscription manager 114 generates a subscriber profile for the user. The generated subscriber profile is stored in database 126.

After configuration, the user may access subscribed energy management modules by using web browser 118 on client device 118. For example, the user may use web browser 118 to view energy management information (e.g., energy data, graphs, or charts) prepared by a subscribed energy management module. The energy data, graphs, or charts may be transmitted to web browser 118 via HTTP responses sent by web server 114.

A user may also access subscribed energy management modules by using a standalone client application 122 on client device 120. In one embodiment, client application 122 communicates directly with a subscribed energy management module to obtain the energy data prepared by the subscribed energy management module. In another embodiment, client application 122 communicates with subscription manager 124 to obtain the energy management information prepared by the subscribed energy management module. In some embodiments, client application 122 requests and receives energy data through RESTful API. In other embodiments, client application 122 may utilize other communication architectures or protocols to request and receive the energy management information. These communication architectures or protocols include, but are not limited to, SOAP, CORBA, GIOP, or ICE. The display of energy data by standalone client application 122 may be further customized depending on the user's special needs.

The non-limiting example in FIG. 1A shows that wireless sensors in building 102 transmit raw energy data directly to energy management service 110. In one alternative embodiment, wireless sensors in building 102 may connect to a gateway wirelessly, and the gateway may transmit raw energy data to energy management service 110. In one example not intended to be limiting, wireless sensors in building 102 may be interconnected with each other in a wireless mesh network. The benefit of the wireless mesh network is that a wireless sensor outside the wireless range to the gateway may nevertheless use other wireless sensors in the wireless mesh network to relay raw energy data to the gateway.

FIG. 1B is a flowchart illustrating an example method 150 for enabling a user to configure energy management of at least one building or project from a remote computing device through an energy management service hosted on a computer network. Method 150 starts at step 152, where energy management service 110 hosts a set of energy management modules. In one embodiment, subscription manager 124 of energy management service 110 hosts the set of energy management modules. The set of energy management modules are configurable for different users subscribed to the energy management service. The user may subscribe to one or more of energy management modules. The modules that the user may subscribe to include, but are not limited to, a building optimization module, portfolio benchmarking module, project tracking module, energy star compliance module, tenant billing module, and public engagement module.

For the subscribed energy management modules to become functional, the user needs to install sensors in the building or the project that the user wants to manage. Installation of the sensors can be at the building or project level. Installation of the sensors can also be at the tenant or equipment level to provide more granular energy data collection. The installed sensors capture raw energy data. Raw energy data captured by the sensors may represent real-time power consumption of the building, project, tenant, or equipment. Installed sensors are also configured to transmit captured raw energy data to energy management service 110 via wireless connections. Once the sensors are installed, subscription manager 124 receives wireless signals from the sensors and extract raw energy data captured by the sensors from the wireless signals. At step 154, subscription manager 124 stores the raw energy data in database 126. In some embodiments, subscription manager 124 may pre-process the raw energy data and store the pre-processed energy data in database 126. For example, subscription manager 124 may aggregate raw energy data into power consumption data in different time periods and store the power consumption data in database 126. In another example, subscription manager 124 may calculate statistics such as total, average, standard deviation, maximum, and minimum values of power consumption data in a specific time period and store them in database 126.

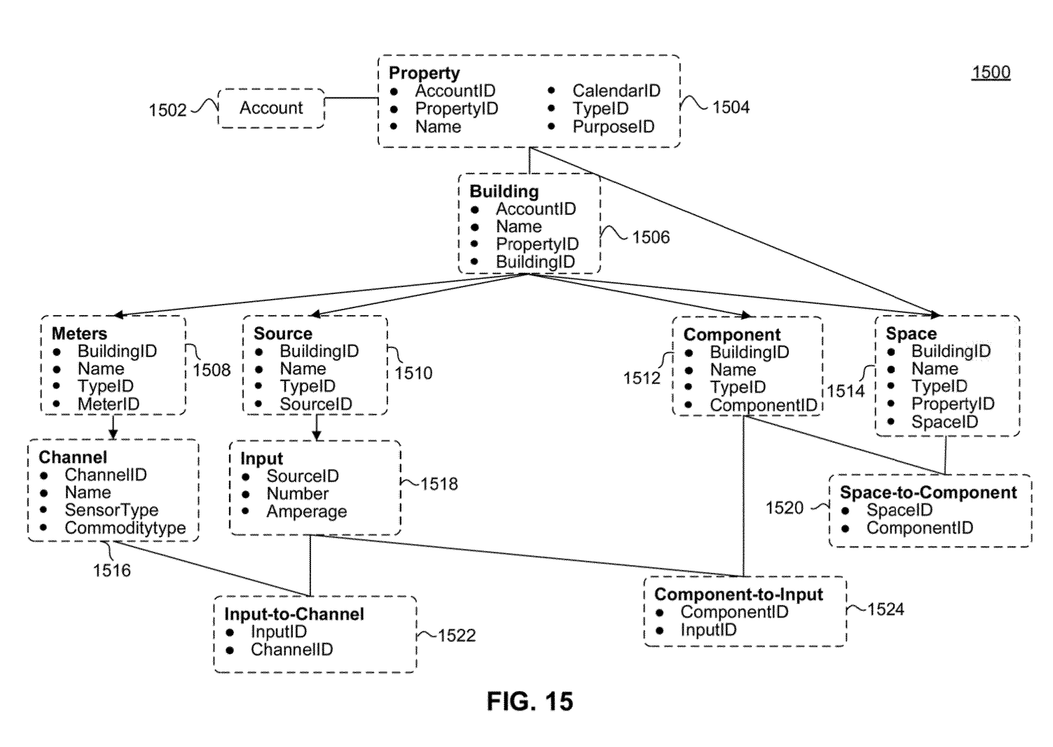

In addition, the subscription manager 124 may store pre-processed energy data as energy management information in a relational data structure, as illustrated in a non-limiting example in FIG. 15.

At step 156, subscription manager 124 receives a request from the user to access the energy management service. The request may be sent by a remote client device used by the user. The user may initiate the request by using web browser 118. Web browser 118 transmits the request to web server 114, and web server 114 forwards the request to subscription manager 124. The user may also initiate the request by using standalone client application 122. In one example embodiment, client application 122 transmits the request directly to subscription manager 124 by utilizing communication architectures or protocols such as RESTful API.

Upon receiving the request to access the energy management service, subscription manager 124 determines which energy management modules are available to the remote user at step 158. In one embodiment, when the user has previously configured to subscribe to some energy management modules, subscription manager generates a subscriber profile associated with the user. The subscriber profile saves information related to what modules the use has subscribed to, and the subscriber profile is saved in database 126. Once subscription manager 124 receives the request to access the energy management service, subscription manager 124 retrieves the subscriber profile associated with the user. Subscription manager 124 then determines energy management modules hosted on energy management service I1 0 based on the information contained in the retrieved subscriber profile.

At step 160, subscription manager 124 uses the energy management modules, determined at step 158, to enable the user to access energy management information. The energy management information relates to energy usage information of a building or a project that the user manages. Energy management information includes energy data processed by either subscription manager 124 or by one of the determined energy management module. For example, the user may access aggregated power consumption data of a building for a time period specified by the user. In another example, the user may access total, average, standard deviation, maximum, and minimum values of power consumption data in a specific time period.

Some energy management modules may provide more advanced energy management information to the user. For example, energy management information can be graphs or charts that help the user to manage energy usage more efficiently in an intuitive manner. One example of energy management information may be a candlestick graph. The candlestick graph can illustrate points of peak energy consumption. The candlestick can also display regions of maximum and minimum energy consumption in the same graph.

In one embodiment, the user may access energy management information by using web browser 118. The energy management information may be presented in web pages downloaded to web browser 118 in HTTP responses. In another embodiment, the user may access energy management information by using standalone client application 122. The energy management information may be returned to client application 122 via communication architectures or protocols such as RESTful API.

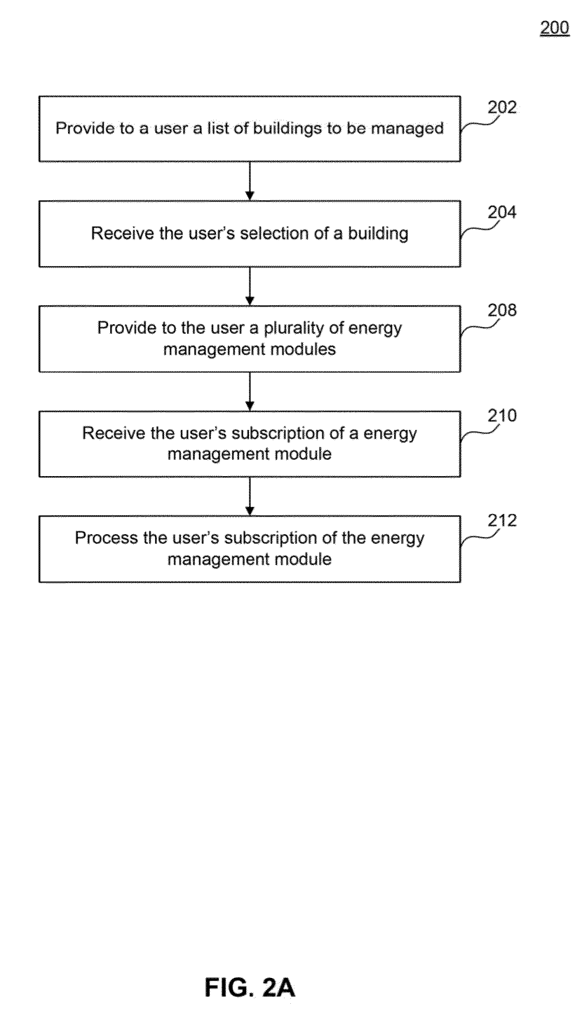

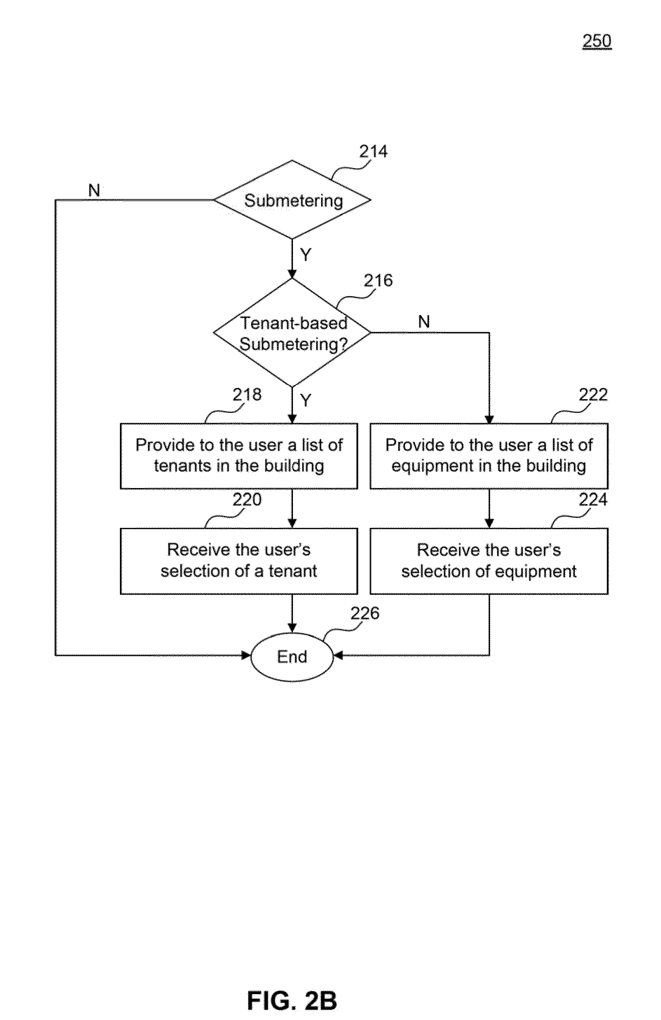

FIG. 2A provides a flowchart illustrating an example configuration method 200 for a user to select and subscribe to one or more energy management modules. Method 200 starts at step 202, where energy management service 110 provides a list of buildings that the user may want to manage energy usage of. In one embodiment, the list of buildings may be presented to the user in a web page returned by web server 114 in an HTTP response, and the user can view the list by using web browser 118. The web page enables the user to select one or more buildings to be managed. Once the user select buildings to be managed, energy management service 110 receives the user's selection at step 204. Installation of sensors in the buildings selected by the user can occur either before or after the user makes the building selection.

Energy management service 110 may also provide a user interface element that allows the user to select and subscribe to one or more energy management modules hosted by energy management service 110. At step 208, energy management service 110 provides the set of energy management modules to the user. In one embodiment, the set of hosted energy management modules may be presented to the user in a web page by web server 114 in an HTTP response, and the user can view the set of modules by using web browser 118. The web page allows the user to select one or more energy management modules for subscription. After the user selects modules for subscription, energy management service 110 receives the user's selection of energy management modules at step 210.

Once energy management service 110 receives the user's selection of buildings and energy management modules, subscription manager 124 process the user's subscription at step 212. In one embodiment, subscription manager 124 can create a subscriber profile associated with the user. The subscriber profile includes information related to the user's subscription of energy management modules. The subscriber profile may also include the user's selection of buildings for energy management. Subscription manager 124 can store the subscriber profile in database 126. Later, when the user decides to change the subscription of energy management modules or the selection of buildings, subscription manager 124 may retrieve the subscriber profile from database 126 and modify the subscriber profile accordingly.

As described, installation of metering sensors may be at the building level. To provide more granular energy management capabilities, sub-metering sensors may be installed at the tenant level or at the equipment level. Thus, steps 202 and 204 may be expanded to enable selection of sub-metering energy management. FIG. 2B is a flowchart illustrating an example method 250 for a user to configure sub-metering energy management. Method 250 starts a 214, where the user decides whether sub-metering energy management is needed. If the user chooses only building-level metering energy management, then method 250 ends at step 226. If the user decides to further configure sub-metering energy management for the building that the user has already selected, energy management service 110 provides an option for the user to choose between tenant-based sub-metering and equipment based sub-metering at step 216. If the user chooses tenant-based sub-metering, energy management service 110 provides a list of tenants in the building to the user at step 218. In one embodiment, the list of tenants may be presented to the user in a web page by web server 114 in an HTTP response, and the user can view the list of tenants by using web browser 118. The web page allows the user to select one or more tenants for energy management. Once the user select tenants to be managed, energy management service 110 receives the user's selection at step 220. If the user chooses equipment-based sub-metering, energy management service 110 provides a list of equipment in the building to the user at step 222. In one embodiment, the list of equipment may be presented to the user in a web page by web server 114 in an HTTP response, and the user can view the list of equipment by using web browser 118. The web page allows the user to select one or more equipment devices for energy management. Once the user select equipment devices to be managed, energy management service 110 receives the user's selection at step 224. Installation of sub-metering sensors in the buildings selected by the user can occur either before or after the user makes the selection of tenants or equipment.

Step 212 may also be expanded to process the user's selection of tenants or equipment. For example, the subscriber profile generated by subscription manager 124 may also contain information related to the user's selection of tenants or equipment.

### 2. Energy Management Modules

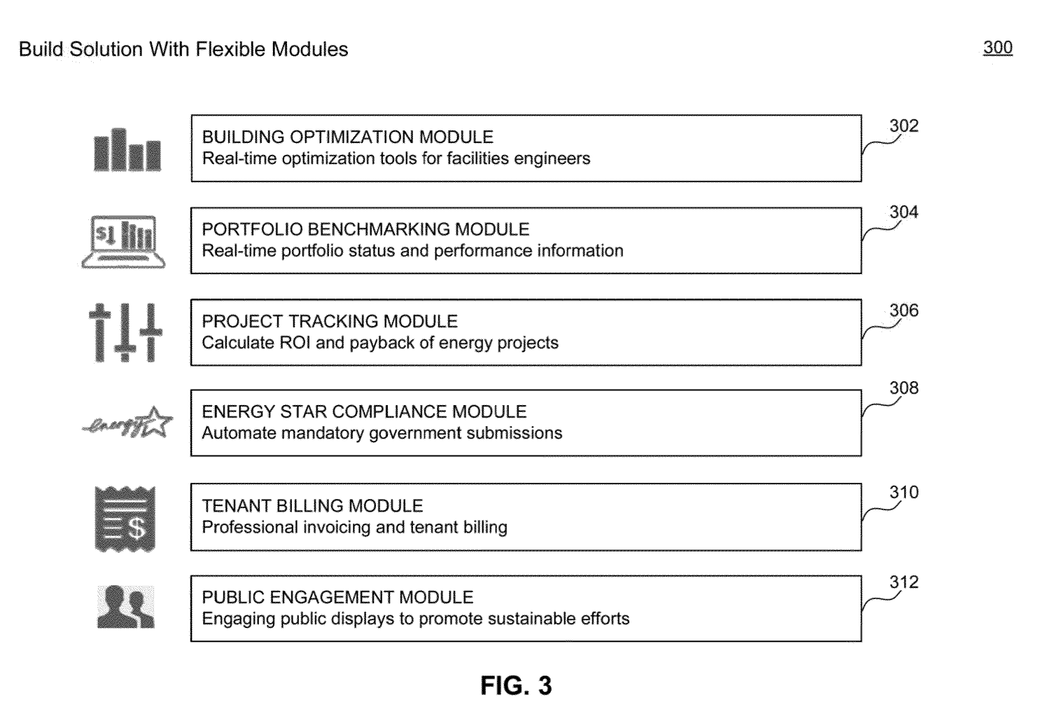

FIG. 3 provides an overview of a set of energy management modules 300 hosted by energy management service 110. The set of energy management modules include, but are not limited to, building optimization module 302, portfolio benchmarking module 304, project tracking module 306, energy star compliance module 308, tenant billing module 310, and public engagement module 312. Building optimization 302 module includes a real-time energy optimization tool for facilities engineers. Building optimization module 302 enables a user to access energy management information by providing the real-time energy optimization tool for display to the remote user on the remote computing device. Portfolio benchmarking module 304 enables a user to access energy management information by providing a user interface element that allows the user to obtain real-time portfolio status and performance information on the energy usage of a portfolio of buildings or projects. Project tracking module 306 calculates ROI and payback of energy projects that the user has invested in. Project tracking module 306 enables a user to access energy management information by providing a user interface element that allows the user to obtain ROI in energy projects. Energy star compliance module 308 automates mandatory government submissions to avoid regulatory fines. Energy star compliance module 308 may provide a user interface element that allows the user at the remote computing device to view and track an energy rating and metrics for a building. Tenant billing module 310 generates professional invoice and tenant billing information. Tenant billing module 310 enables a user to access energy management information by providing a user interface element that allows the user to view and analyze invoice and billing information of the building or project managed by the user. Public engagement module 312 engages in public displays of certain energy management information of a building, chosen by the user managing the building, to promote sustainable effort. Public engagement module 312 provides a user interface element that allows the public to view the chosen energy management information of the building.

### 3. Example Raw Energy Data Processing

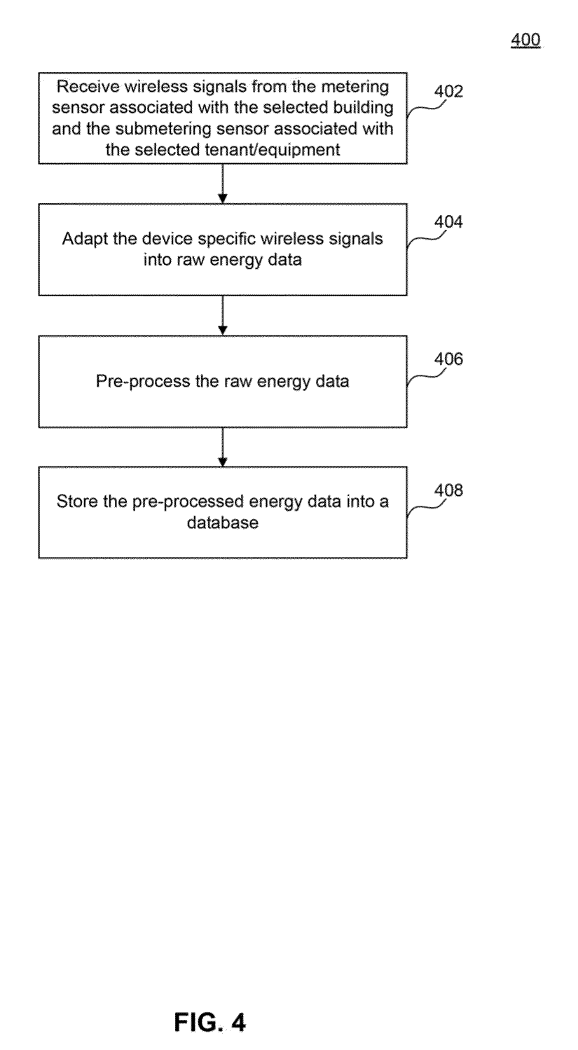

FIG. 4 provides a flowchart illustrating an example method 400 for subscription manager 124 to pre-process raw energy data received from metering sensors and sub-metering sensors. At step 402, subscription manager 124 receives wireless signals from the metering sensors installed in the selected building. If the user has also configured sub-metering energy management, subscription manager 124 receives wireless signals from sub-metering sensors installed in the selected building as well. At step 404, subscription manager 124 may use device specific adaptors to adapt device specific wireless signals into raw energy data. In some embodiments, the device specific adaptors allow subscription manager 124 to extract raw energy data encoded in the format specific to the model type of the sensors. At step 406, subscription manager 124 may pre-process the raw energy data. For example, subscription manager 124 may aggregate raw energy data into power consumption data in different time periods. In another example, subscription manager 124 may calculate total, average, standard deviation, maximum, and minimum values of power consumption data in a specific time period. At step 408, subscription manager 124 then stores pre-processed energy data in database 126. Pre-processing allows energy management modules to prepare energy manage information from pre-processed energy data, rather than from raw energy data received from metering sensors and sub-metering sensors. Such preparation Is more efficient and enables energy management modules to present energy management information to the user in real-time when requested.

### 4. Example Accessing of Sensed Energy Data

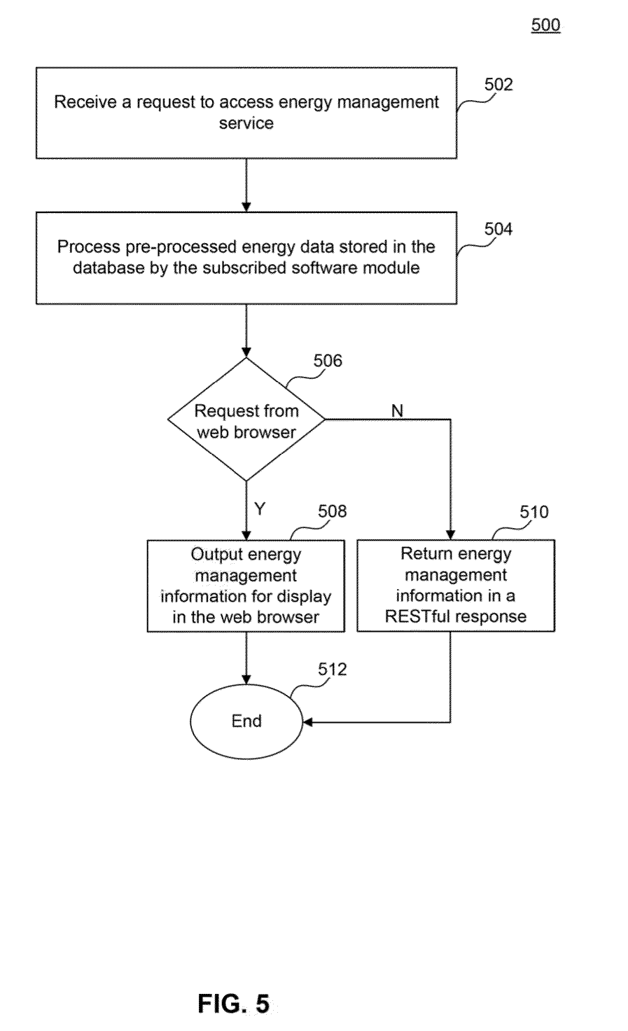

FIG. 5 is a flowchart illustrating an example method 500 for a user to access energy management service based a subscribed energy management module, according to one embodiment. Method 500 starts at step 502, where energy management service 110 receives a request to access energy management service from a user using a remote client device. At step 504, the subscribed energy management module processes energy data stored in database 126. In one embodiment, the subscribed energy management module processes energy data pre-processed by subscription manager 124 and stored in database 126. The subscribed energy management module processes energy data to generate energy management information to be presented to the user. The type of energy management information depends on the request type. The energy management information may also be aggregated or partitioned of energy data. The energy management information may also be graphs or charts that provide visual aids for the user to make fast and accurate analysis.

At step 506, the subscribed energy management module determines whether the request comes from a web browser. If the request is from a web browser, such as web browser 118 used by the user, the subscribed energy management module communicates with web server 11 4 to output generated energy management information for display in web browser 118 at step 508. If the request is from another communication means, energy management information is returned by using the same communication means at step 510. For example, the user might use standalone client application 122 to send the request in RESTful API to access energy management service. Energy management information, prepared by the subscribed energy management module, can be returned in RESTful API to client application 122. Method 500 ends at step 512.

### 5. Example Energy Management Module Interfaces

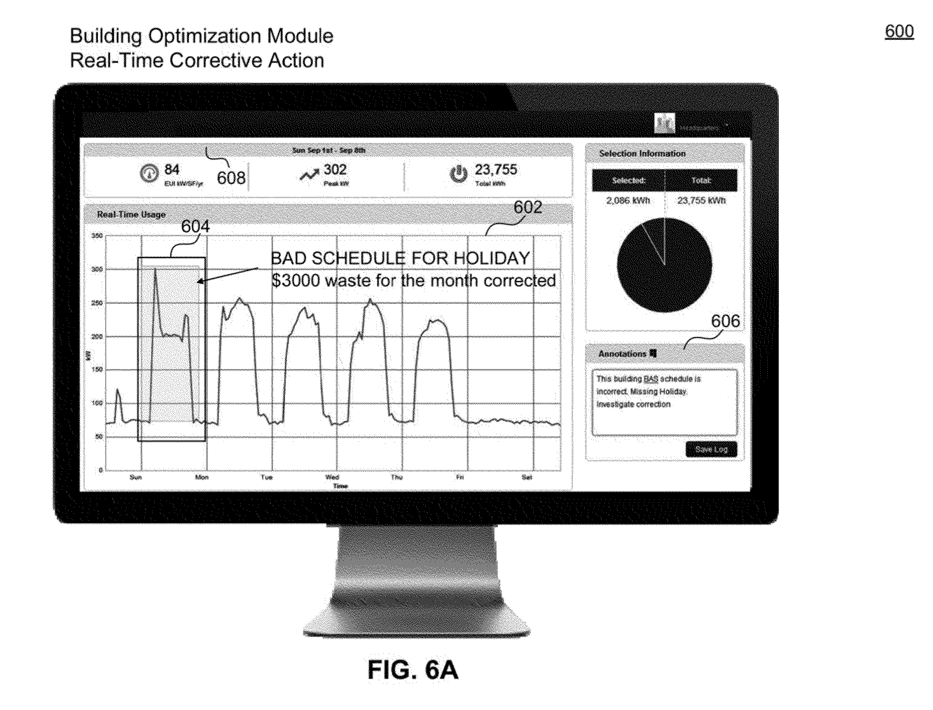

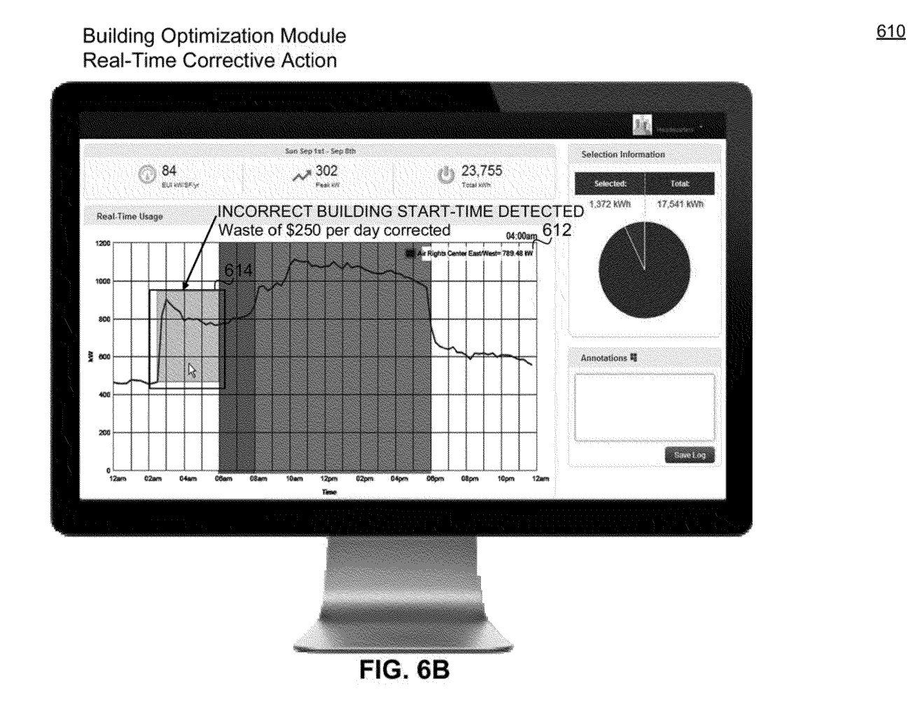

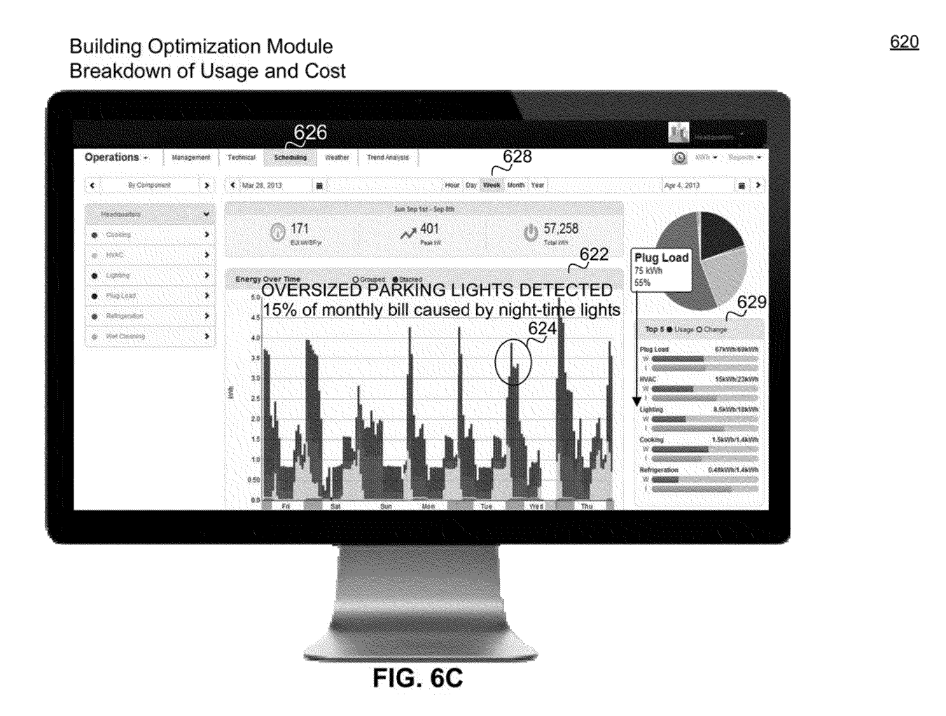

FIG. 6A illustrates an interface provided by a building optimization module. Interface 600 helps a user to take real-time corrective actions based on energy management information presented by interface 600. Interface 600 includes section 608 which displays statistics of energy consumption over a selected time period. Statistics displayed in section 608 may include peak power consumption and total power consumption. Chart 602 may show daily real-time energy usage over the time period of a week. Chart 602 helps the user to identify bad holiday schedules for energy consumption. For example, if area 604 in chart 602 shows unusually high energy consumption on a Sunday, the user can determine that the schedule is incorrect because energy consumption on a holiday, such as a Sunday, should be low. The user can enter and save annotations in text area 606 for further investigation.

FIG. 6B illustrates another interface provided by a building optimization module that helps a user to take real-time corrective actions based on energy management information presented by the interface. Interface 610 includes chart 612. Chart 612 shows hourly real-time energy usage over the time period of a day. Chart 612 helps the user to detect incorrect start time for energy consumption. For example, if area 614 in chart 612 shows usually high energy consumption from 2:00 am to 6:00 am, the user can determine that the schedule is incorrect because energy consumption during early morning hours should be low. As in interface 600, the user can enter and save annotations for further investigation.

FIG. 6C illustrates another interface provided by a building optimization module that breaks down energy usage and cost. Interface 620 includes tab area 626. Tab area 626 enables the user to select management, technical, scheduling, weather, or trend operations. When the user clicks on the scheduling tab, a scheduling operation view is presented to the user. In the scheduling operation view, the user may select different time periods in section 628 for energy usage schedules. The length of time periods can vary by the hour, day, week, month, or year. Chart 622 may display energy usage by the type of devices. For example, section 624 allows the user to detect oversized parking lights. Area 629 may also display a ranking of top energy consuming devices by usage or by change.

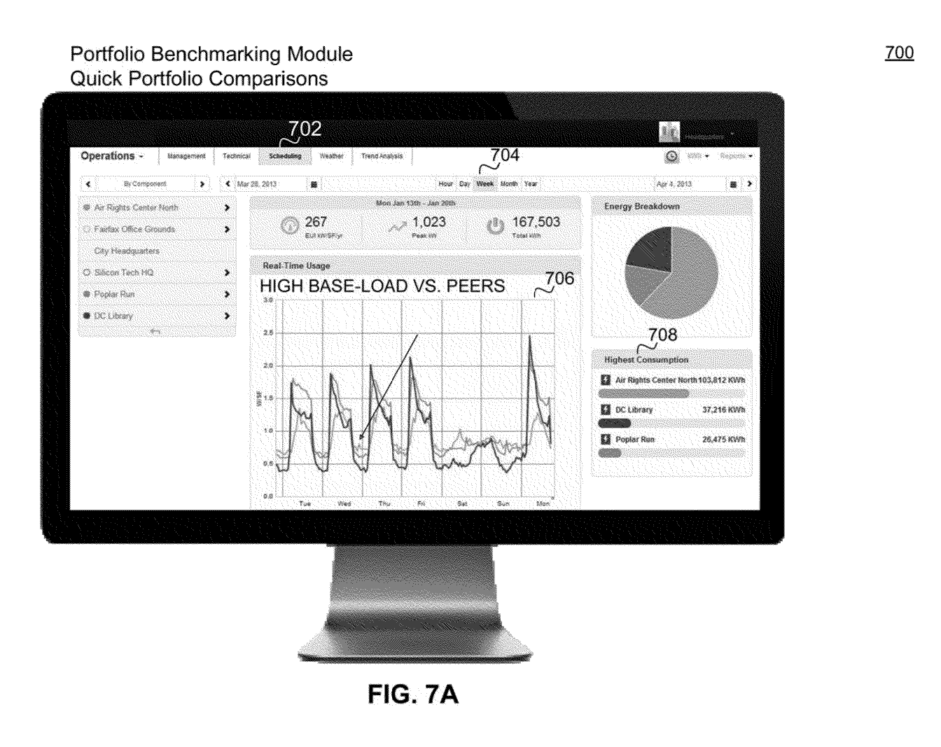

FIG. 7A illustrates an interface provided by a portfolio benchmarking module. When the user clicks on the scheduling tab in tab area 702, a scheduling operation view is presented to the user. In the scheduling operation view, the user may select different time periods in section 704 for peer energy usage comparison. The length of time periods can be by the hour, day, week, month, or year. Chart 706 may display energy usage of the user selected building, tenant, or equipment as compared to energy usage of peers. Each peer's energy usage may be displayed by a separate line in a color different from the color for the user selected building, tenant, or equipment. Section 708 may display a rank of peers with the highest consumption.

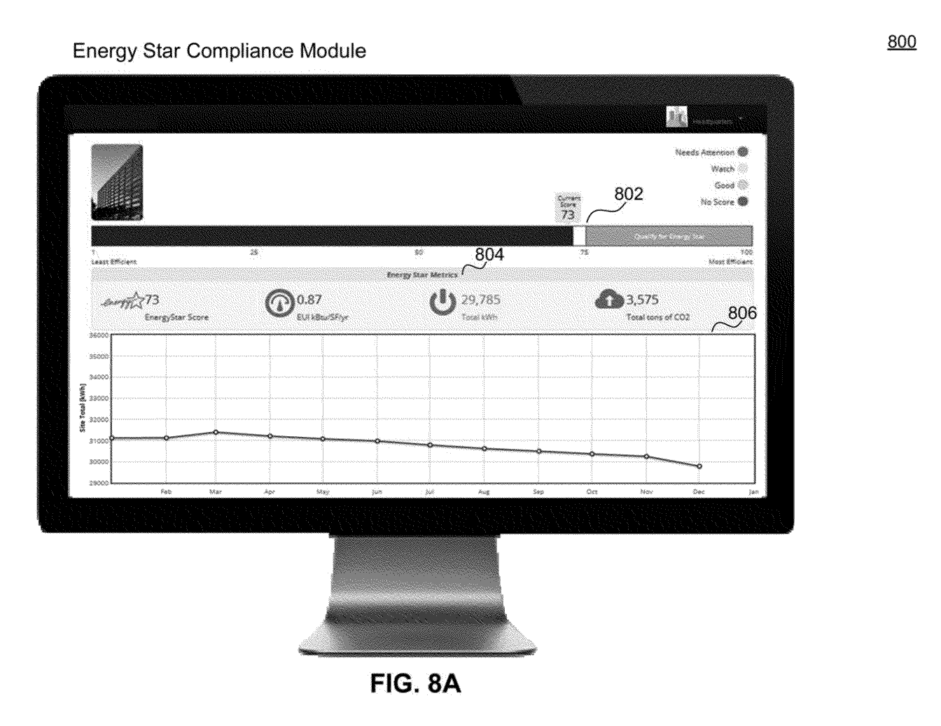

FIG. 8A illustrates an interface provided by an energy star compliance module. A energy star compliance module can determine energy star related metrics. Interface 800 includes energy star metrics area 804. Metrics area 804 displays an energy star score of the user selected building, tenant, or equipment. Metrics area 804 also displays other energy star related metrics such as energy consumption, and total tons of C02 emitted. Status bar 802 shows the status regarding the energy star score determined by the energy star compliance module. Chart 806 shows the energy consumption trend over a period of time for energy star compliance purpose. Energy Star is one example not intended to be limiting and compliance with other ratings can be evaluated.

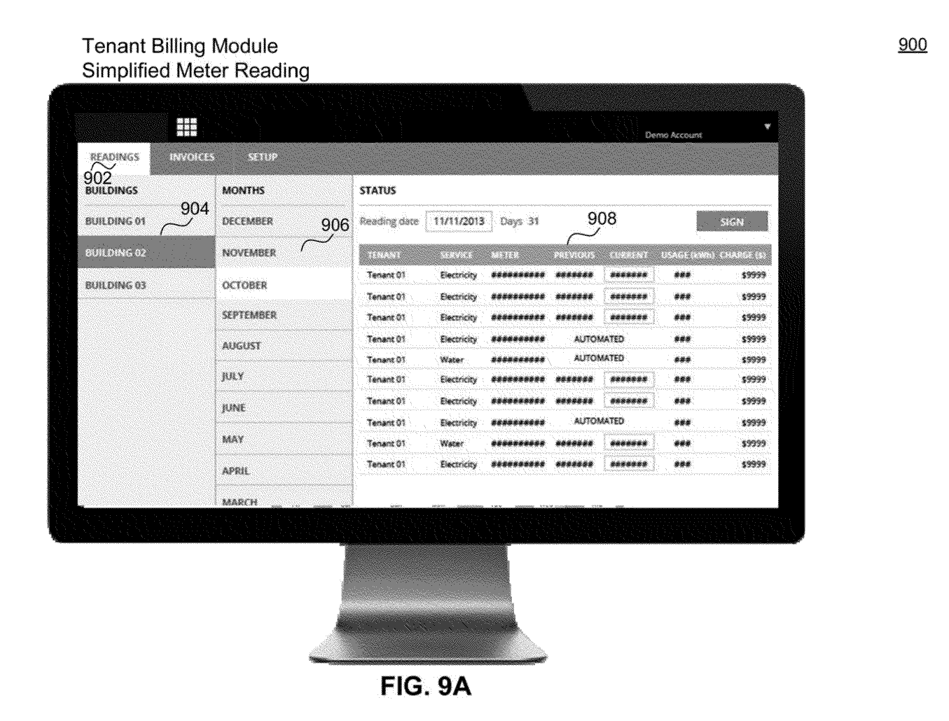

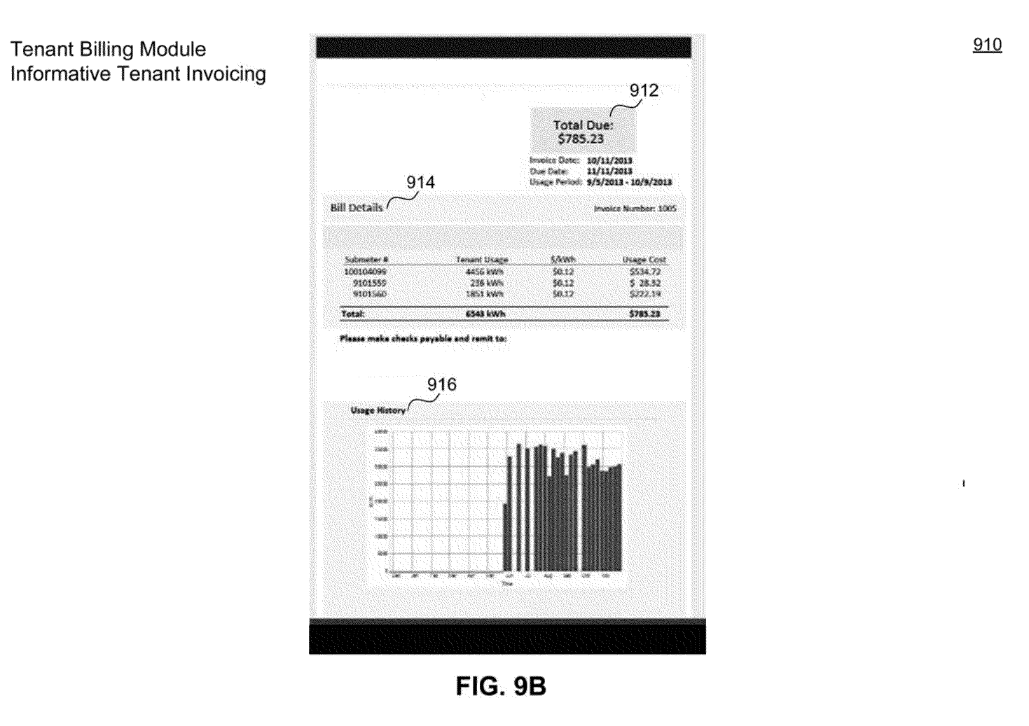

FIG. 9A illustrates an interface provided by a tenant billing module. Interface 900 simplifies meter reading for the user. When the user wants a quick access meter readings, the user can select reading tab 902. Within readings tab 902, a list of buildings managed by the user is presented to the user. After the user selects a building in section 904 and a month in section 906, section 908 displays a status summary for all tenants of the selected building in the selected month. Information in section 908 includes type of service, meter reading, energy usage, and charges in dollar value associated with each tenant.

FIG. 9B illustrates another interface provided by a tenant billing module. Interface 910 shows a more detailed and informative invoicing for a tenant in a selected month. Section 912 displays the total due that the tenant needs to pay. Section 914 displays details of the bill, including energy usage data for each sub-meter and usage cost for each sub-meter. Chart 916 provides a view of energy usage history.

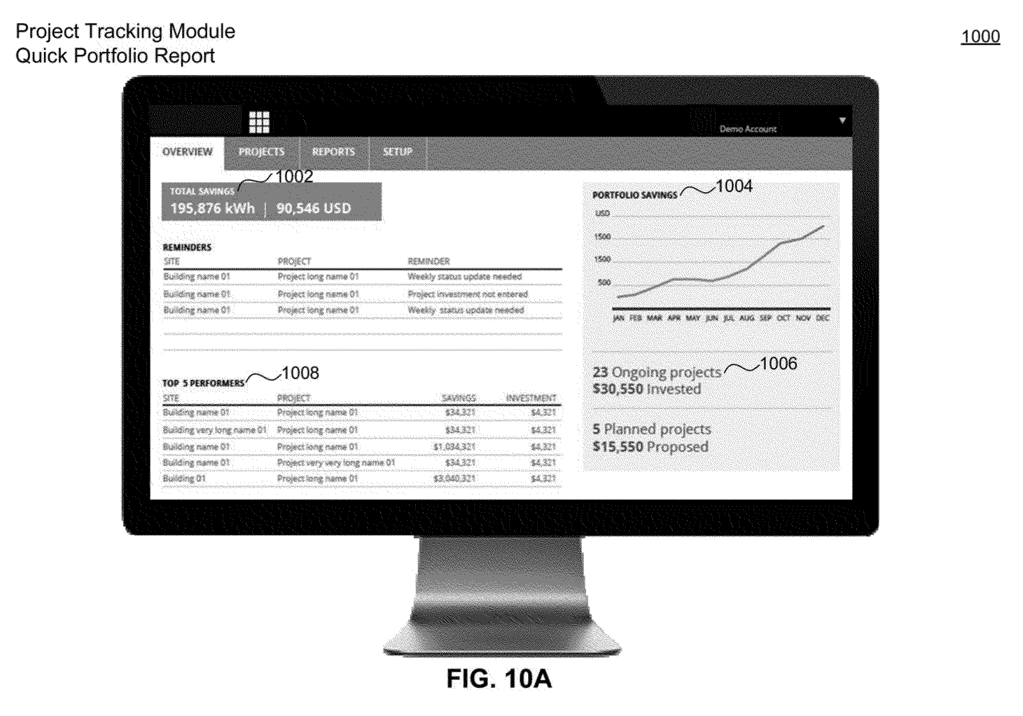

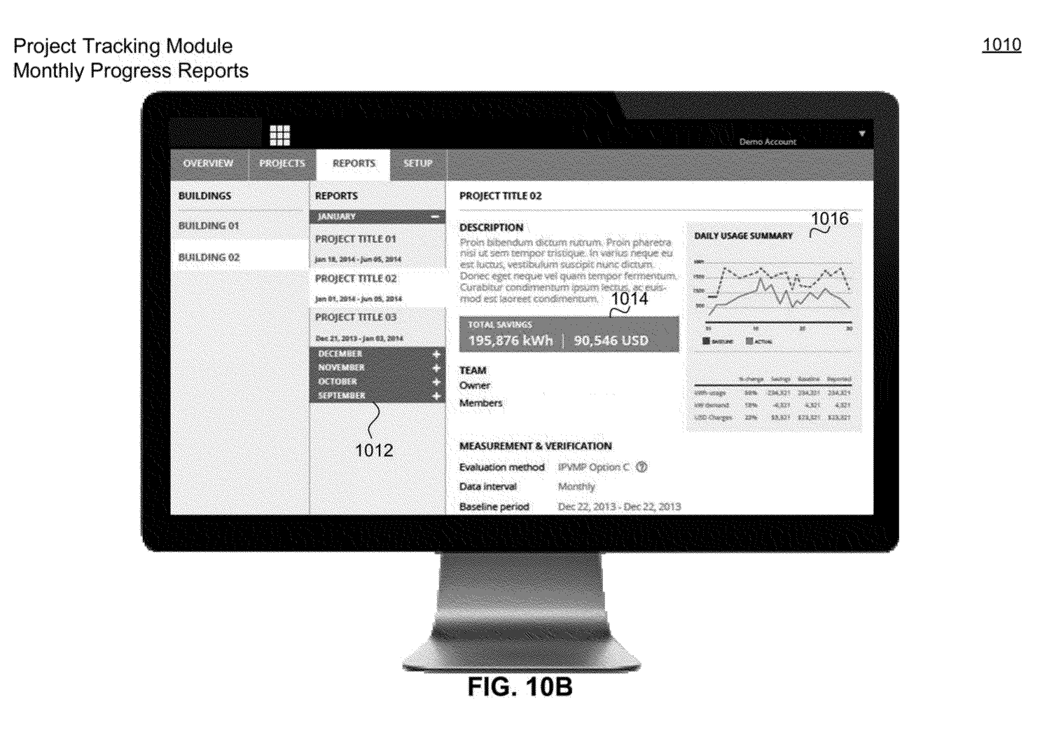

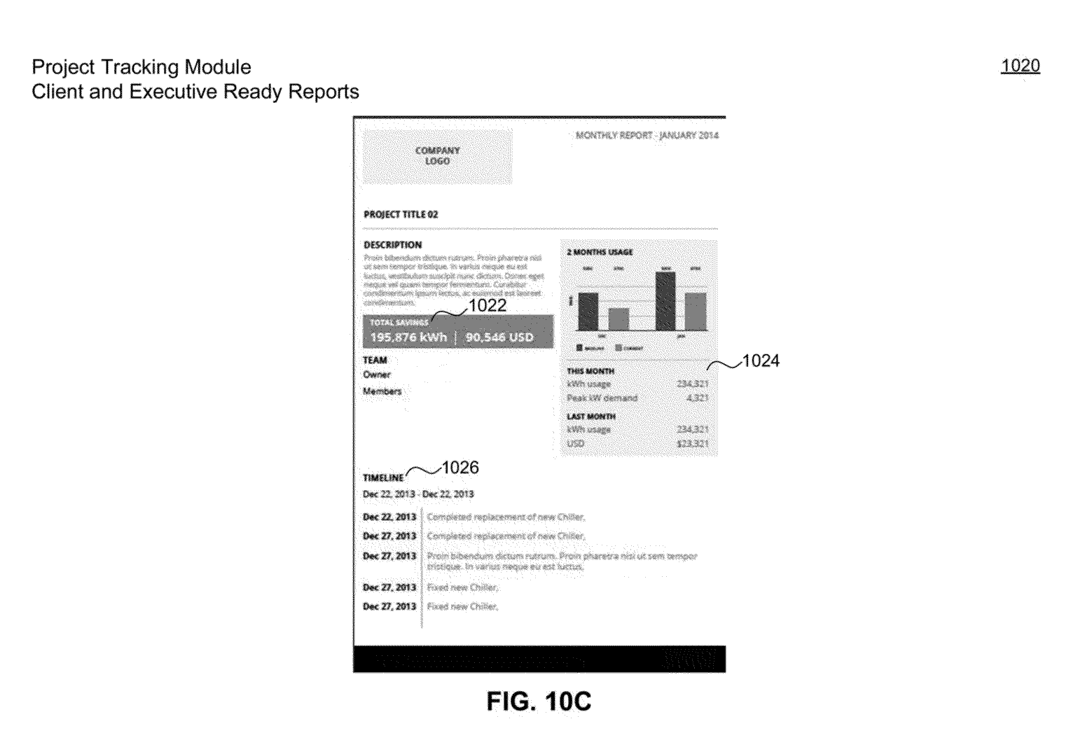

FIG. 10A illustrates an interface provided by a project tracking module. Interface 1000 provides a quick portfolio report of the project. Section 1002 displays total savings in terms of energy consumption and dollar value. Chart 1004 displays the portfolio savings over a period of time. Section 1006 displays the total number of ongoing projects and total investment in the ongoing projects. Section 1006 may also display the total number of planned projects and total investment in the planned projects. Section 1008 may provide a ranking of top performing projects. The ranking may be based on the total savings of the projects. The ranking may also be based on ROIs of the projects.

FIG. 10B illustrates another interface provided by a project tracking module. Interface 1010 provides a view for monthly progress report. Section 10 I2 allows the user to select a month for the progress report. Section 1014 displays total savings for the selected month in terms of total energy savings and dollar value. Chart 1016 shows the daily usage summary over the selected month.

FIG. 10C illustrates another interface provided by a project tracking module. Interface 1020 provides a view for client and executive ready report. Section I 022 displays total savings for the selected month in terms of total energy savings and dollar value. Chart I 024 provides a 2-month usage comparison. Section I 026 lists a timeline of events occurred in the selected month for the project.

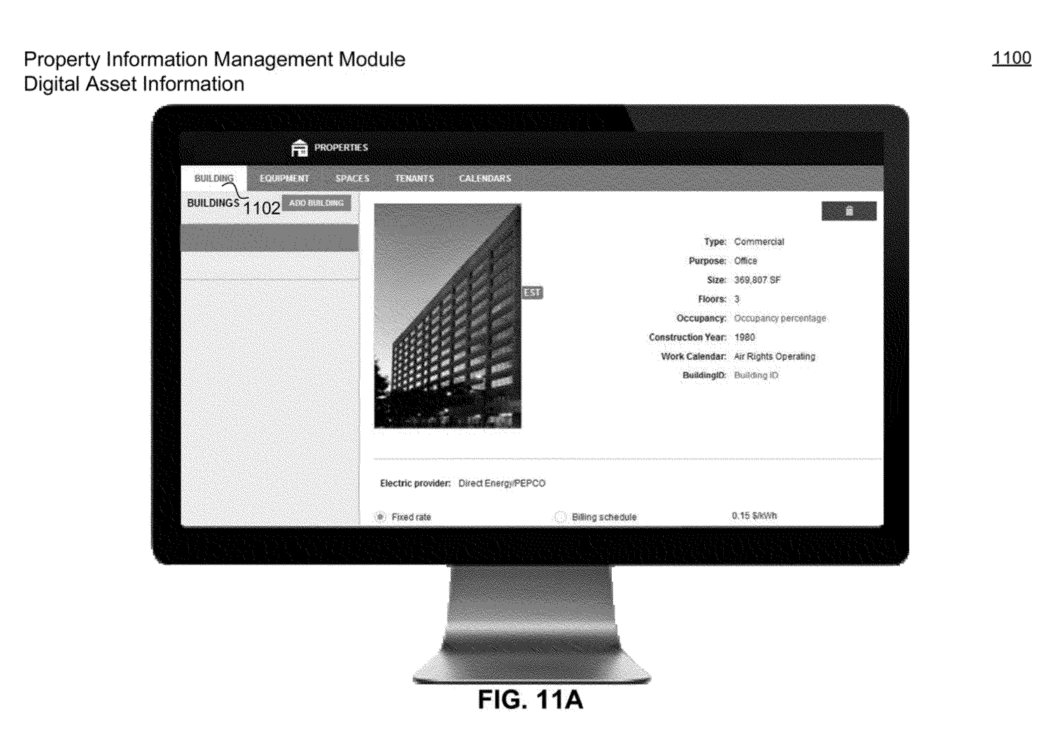

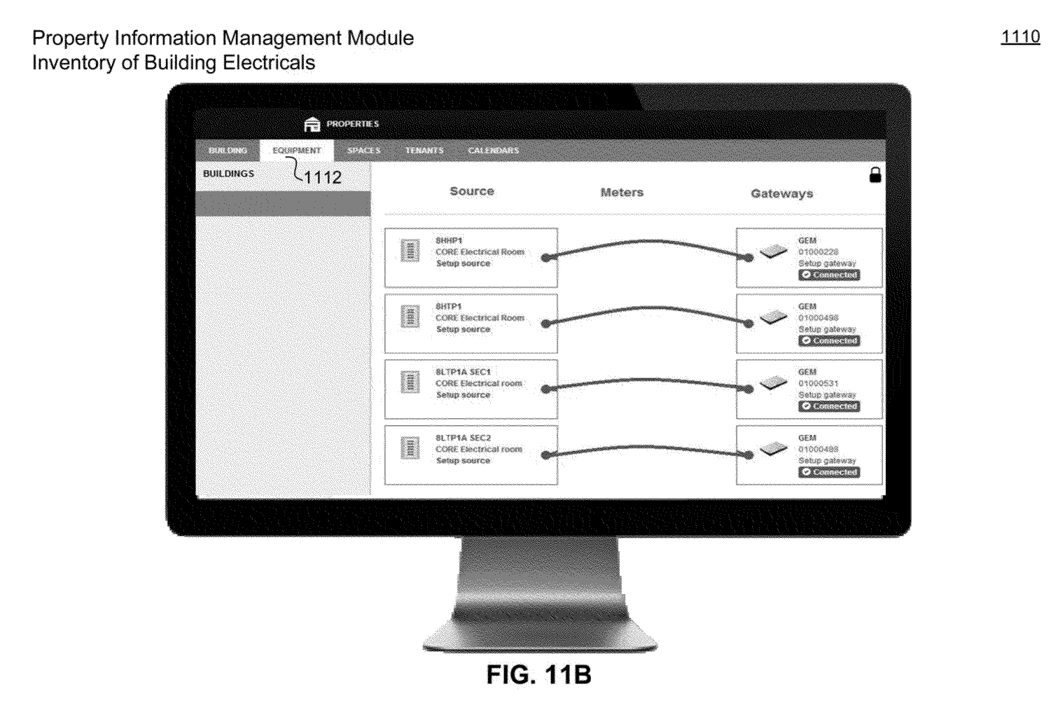

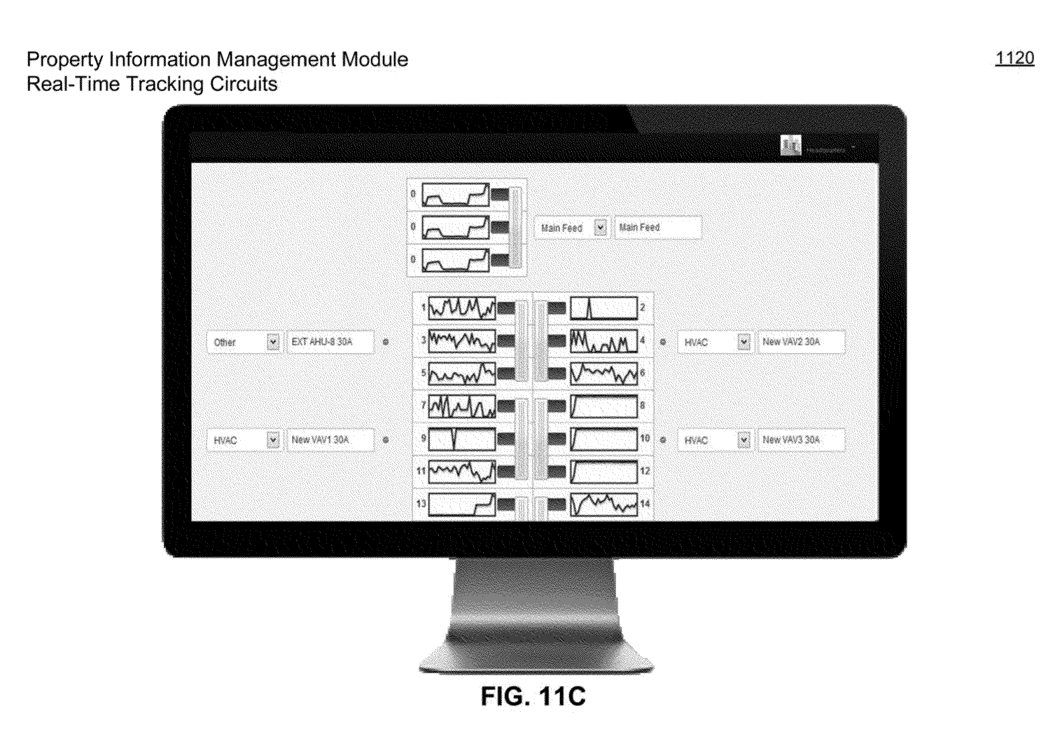

FIG. 11A illustrates an interface provided by a property information management module. When the user selects the building tab, interface 1100 may present basic information about a selected building.

FIG. 11B illustrates another interface provided by a property information management module. When the use selects the equipment tab, interface 1110 may present inventory information of electrical equipment in the building.

FIG. 11C illustrates another interface provided by a property information management module for real-time tracking of circuits.

### 6. Data Aggregation and Partitioning

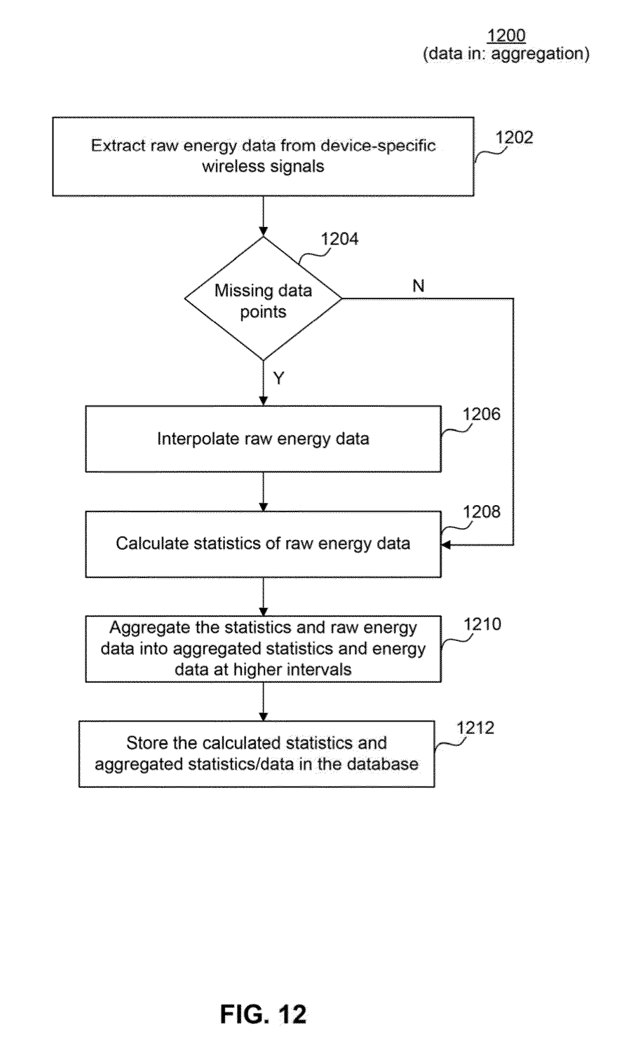

FIG. 12 is a flowchart illustrating another example method 1200 for the subscription manager to pre-process raw energy data received from the wireless sensors. At step 1202, subscription manager 124 uses an adaptor to extract raw energy data from device-specific wireless signals. At step 1204, subscription manager 124 determines whether there are missing energy data points in the raw energy data. If there are no missing energy data points, method 1200 proceeds to step 1208. If there are missing energy data points, subscription manager 124 fills in the missing data points by interpolating available raw energy data at step 1206. At step 1208, subscription manager 124 calculates statistics of raw energy data. The statistics data may include the total, average, standard deviation, maximum, and minimum values of power consumption data in a specific time period. At step 1210, subscription manager 124 aggregates the statistics and raw energy data into aggregated statistics and energy data at higher intervals. For example, statistics over minutes can be aggregated to statistics over hours. Statistics over hours can be aggregated to statistics over days, and so on. At step 1212, subscription manager 124 stores calculated statistics and aggregated statistics/energy data in database 126.

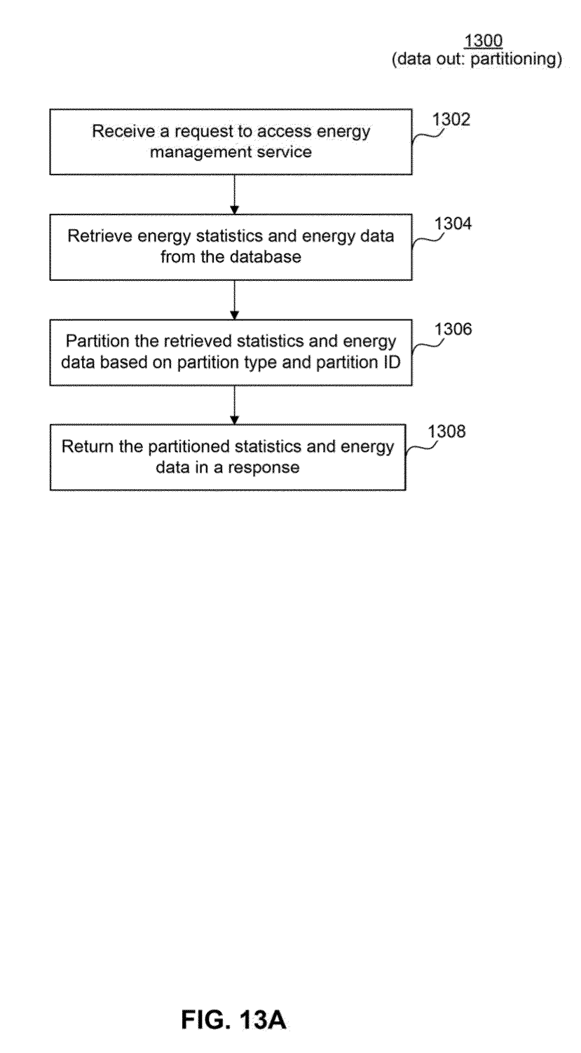

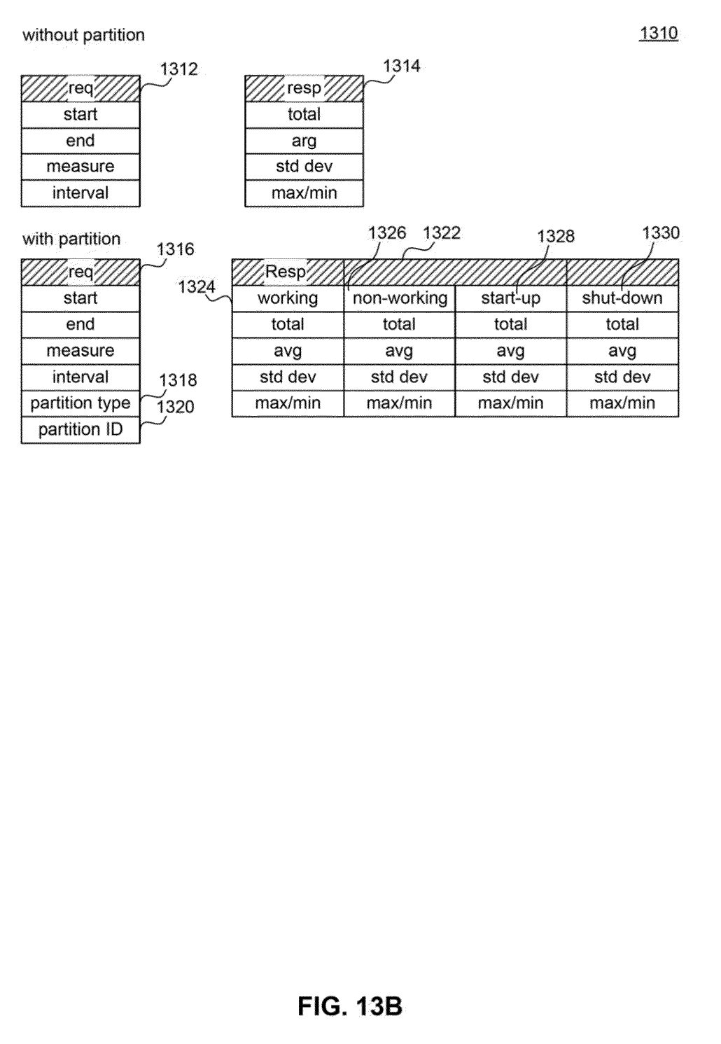

FIG. 13A is a flowchart illustrating an example method 1300 for the subscription manager to process a request to access paliitioned energy management information. Method 1300 may be performed in conjunction with method 1200. At step 1302, subscription manager 124 receives a request to access energy management service. At step 1304, subscription manager 124 retrieves energy statistics and energy data from database 126. The retrieved statistics and energy data may be aggregated statistics and energy data as the result of method 1200. If the request contains partition information such as a partition type and a partition ID, subscription manager 124 partitions the retrieved statistics and energy data based on the partition type and the partition ID at step 1306. Subscription manager 124 then returns the partitioned statistics and energy data in a response at step 1308.

FIG. 13B provides example data structures of requests and responses for the user to access energy management service 110. Request 1312 is used to request energy management information without partitioning. For example, request 1312 may contain start and end time of a time period, the type of energy measurement, and the interval. In response to request 1312, response 1314, returned by energy management service 110, includes energy management information for the requested time period. For example, response 1314 may include total, average, standard deviation, maximum, and minimum values of power consumption in the time period specified in request 1312.

Request 1316 is used to request energy management information with partitioning. In addition to the fields used by request 1313, request 1316 includes two more fields, one for partition type and another for partition ID. In response to request 1316, response 1322 contains energy statistics for each paliition. For example, in response 1322, each of working hour partition 1324, non-working hour partition 1326, start-up hour partition 1328, and shut-down hour partition 1330 may include separate a separate set of total, average, standard deviation, maximum, and minimum values.

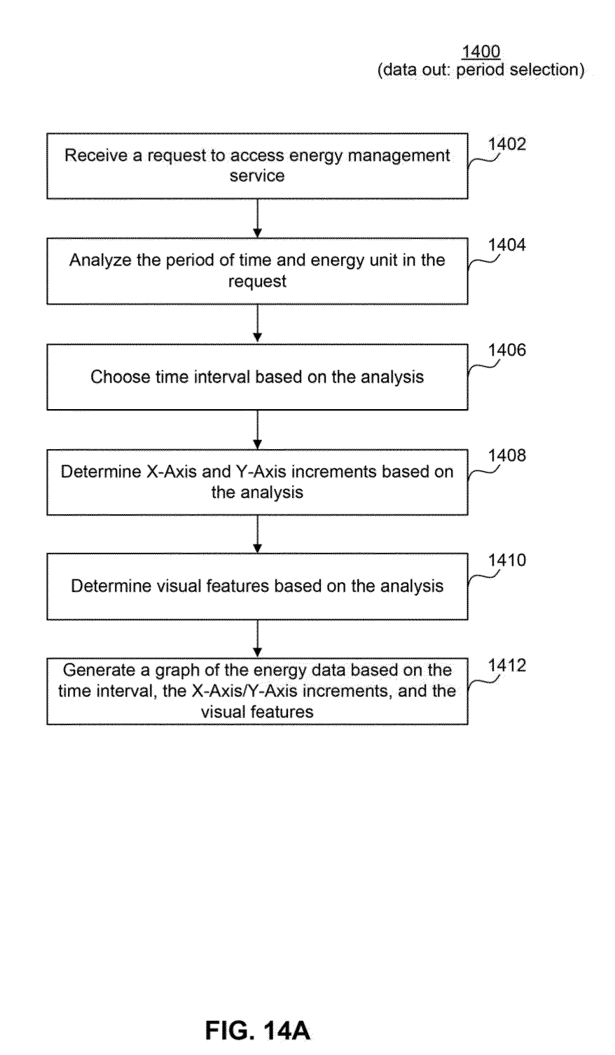

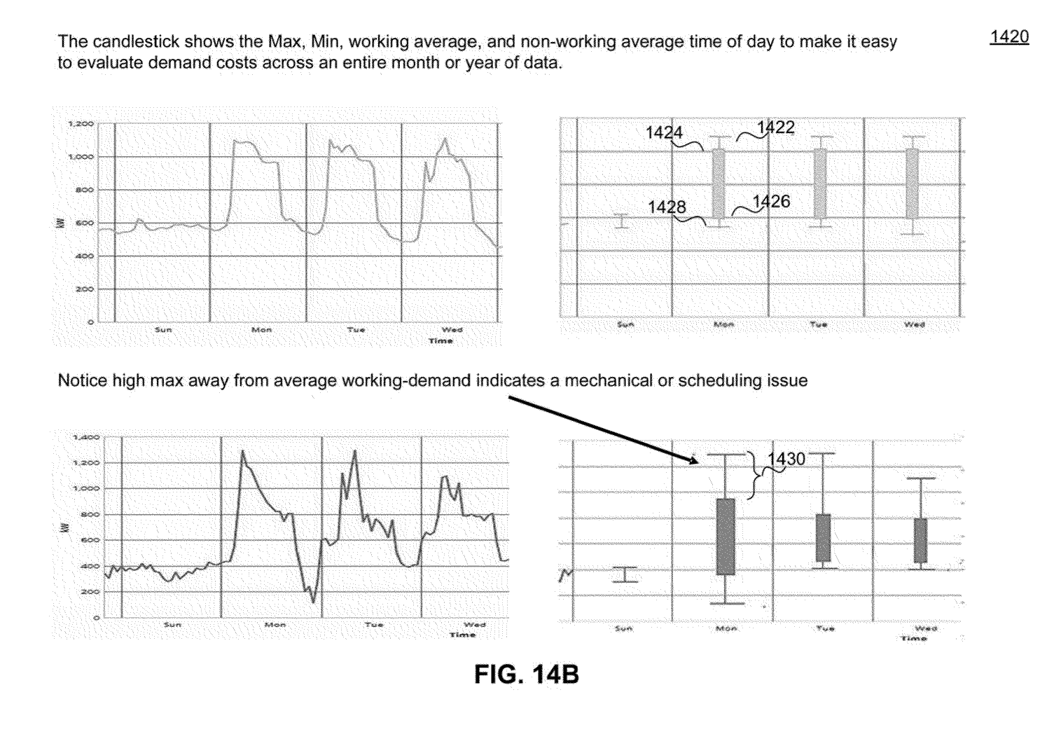

FIG. 14A is a flowchart illustrating an example method 1400 for automatically choosing an optimized time interval for a display prepared by an energy management module. At step 1402, subscription manager 114 receives a request to access energy management service. At step 1404, subscription manager 114 analyzes the time period and energy unit included in the request. At step 1406, subscription manager 114 determines a time interval based on the analysis performed at step 1404. At step 1408, subscription manager 114 determines the X-Axis and Y-Axis increments based on the analysis performed at step 1404. At step 1410, subscription manager 114 determines visual features used based on the analysis performed at step 1404. At step 1412, the subscribed energy management module generates a graph of energy data based on the time interval, the X-Axis and Y-Axis increments, and the visual features determined by subscription manager 114.

FIG. 14B provides an example of a candlestick graph for displaying energy data. For example, sections 1422 and 1428 of a candlestick graph are used to display maximum and minimum values of energy data respectively. Section 1424 and 1426 of the candlestick graph display working average and non-working average of energy data respectively. The candlestick visual feature can help the user to quickly detect certain scheduling issues. For example, normally, the working average energy consumption should be close to the maximum energy consumption. Thus, a large gap between the working average energy consumption and the maximum energy consumption, as shown in section 1430 of a candlestick graph, indicates a mechanical or scheduling issues.

### 7. Example Relational Data Structure

FIG. 15 illustrates an example relational data structure that represents electrical infrastructure of a building. Objects in relational data structure 1500 represent entities such as buildings or wireless sensors. In addition, objects in relational data structure 1500 are organized in a hierarchy that represents electrical infrastructure of the building.

A user can have an account with the energy management service. A user account object in the relational data structure represents the user's account. The user account object may be associated with one or more property objects in the relational data structure. For example, user account object 1502 is associated with property object 1504. Properties are an abstraction of buildings or spaces. A building is a whole structure such as an office building or a grocery store. A space is an area or a part within a building. Examples of a space include, but not limited to, an apartment, an office floor, or a kitchen within the building. Property object 1504 may be associated with building object 1506 or space object 1514. Building object 1506 represents a physical building, such as building 102 in FIG. 1.

A building may include many sensors, electrical devices, and breaker panels, etc. Thus, building object 1506 in relational data structure 1500 may be associated with one or more meter objects such as meter object 1508. Meter objects represent electricity data collecting devices such as wireless sensors 104, 106, and 108 in FIG. 1. Building 1506 may be associated with one or more component objects such as component object 1512. Component objects represent components that consume electricity. Examples of components include, but not limited to, lights, refrigerators, or elevators. Building 1506 may also be associated with one or more source objects such as source object 1510. Source objects represent sources. Sources provide electricity energy source and transfer electricity to components. Examples of sources include, but not limited to, breaker panels or utility meters. Since a space is a part within a building, building object 1506 may be associated with one or more space objects representing the spaces within the building.

A wireless sensor may measure raw energy data of several equipment devices. Raw energy data for each equipment device may be transmitted via a separate channel. Thus, a meter object may be associated with one or more channel objects representing energy data transmitted for one equipment device. For example, meter object 1508 may be associated with channel object 1516.

A source object may be associated one or more input objects that represent inputs. For example, source object 1510 may be associated with input object 1518. An input may be a feed input or a load input. A feed input for a source provides electricity to the source. A load input for a source supplies electricity from the source to a component or a sub-source of the source.

Relational data structure 1500 may establish an association between two objects by storing the ID of one object in the other object. For instance, the non-limiting example in FIG. 15 shows that meter object 1508 stores a building ID. The building ID in meter object 1508 establishes the association with building object 1506 having the same building ID. Similarly, the building IDs in source object 1510, component object 1512, and space object 1514 establish associations with building object 1506 respectively.

Relational data structure 1500 may also establish an association between two objects by storing the IDs of the two objects in an association link. For instance, the non-limiting example in FIG. 15 shows that space-to-component association link 1520 stores IDs of component object 1512 and space object 1514. Thus, space-to-component association link 1520 establishes an association between component object 1512 and space object 1514. Similarly, component-to-input association link 1524 establishes an association between component object 1512 and input object 1518, and input-to-channel association link 1522 establishes an association between input object 1518 and channel object 1516.

Once the relational data structure is set up in the database, energy management service 110 may store energy management information in the relational data structure in the database. For example, once energy management service 110 receives raw energy data captured by one of the wireless sensors in building 102, subscription manager 124 may parse the raw energy data to extract channel information. The extracted channel information may include a channel number and a serial number of the wireless sensor. Based on the channel information, subscription manager 124 can search and find the channel object in the relational data structure. Subscription manager 124 may process the raw energy data to generate energy management information. The processing may involve converting the raw energy data in a uniform format acceptable by database 126. The process may additionally involve data aggregation and/or statistics calculation. Then subscription manager 124 may store the energy management information in the relational data structure as being associated with the channel object.

Since energy management service 110 may store energy management information in a relational data structure such as the one illustrated in FIG. 15, a user can view the energy management information in a more intuitive user interface with better intelligence and granularity. For example, energy management service 110 may include a property information management module for displaying energy management information organized in a hierarchy corresponding to the relational data structure.

In a non-limiting embodiment, the property information management module may retrieve the energy management information from the relational data structure in the database. Based on the energy management information, the property information management module can use the relational data structure to identify the account object, the property object, the building object, the space object, the meter object, the source object, and the component object in the hierarchy. The property information management module may then display the energy management information with descriptive information stored in the account object, the property object, the building object, the space object, the meter object, the source object, and the component object in the hierarchy corresponding to the relational data structure. The descriptive information may include a descriptive name for the object such as a building name or an equipment name.

The descriptive information may include additional information such as the location or type of the equipment or breaker panels. The property information management module also displays in the user interface hierarchical information corresponding to the relational data structure. In this way, the user interface presents a user a topology of how sensors, equipment, sources, etc. are installed and connected in a building. For example, a user can see not only which wireless sensor captures the energy data but also additional information such as which device consumed the energy, what breaker panel feeds the device, and in what building and on which floor is the device located.

When the property information management module displays energy management information retrieved from the database, associations among objects in the relational data structure has already been established. Thus, the property information management module may identify objects to be displayed using the associations in the relational data structure. For example, the property information management module may identify that channel object 1516 is associated with the retrieved energy management information and meter object 1508 is associated with channel object 1516. From meter object 1508, the property information management module may identify building object 1506 from meter object 1508, property object 1504 from building object 1506, and user account object 1502 from property object 1504.

Many objects in relational data structure 1500 are associated with other objects directly or indirectly. A person skilled in the art may recognize that different association paths in the relational data structure can be used to retrieve the same objects to be displayed. In an alternative example, after the property information management module identifies channel object 1516, the property information management module may identify building object 1506 through input-to-channel association link 1522, input object 1518, and source object 1510.

### 8. Example Computer System

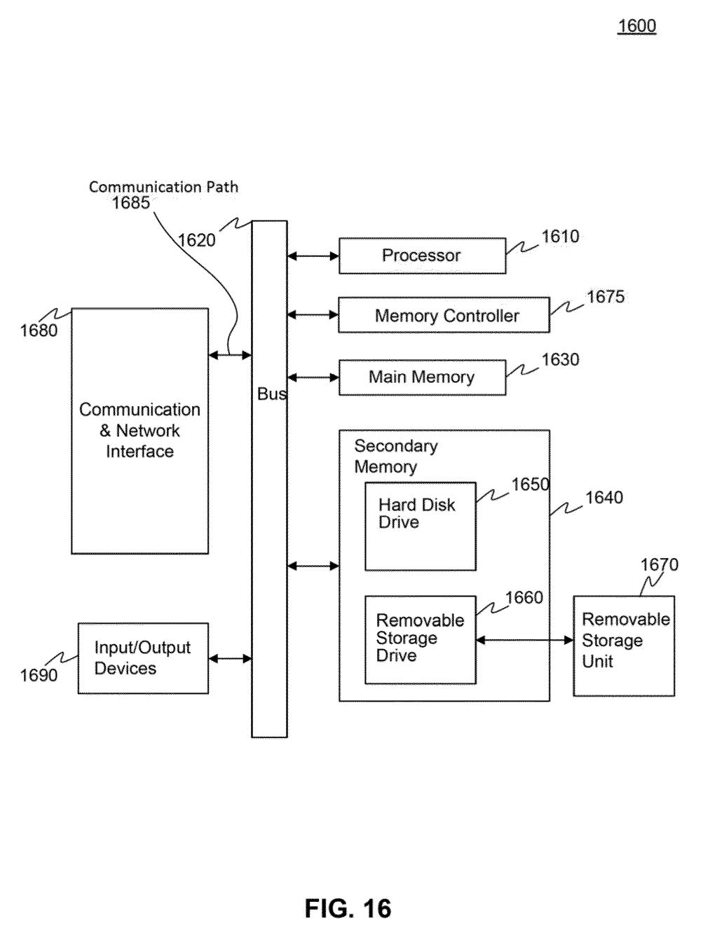

Various aspects of the disclosure can be implemented on a computing device by software, firmware, hardware, or a combination thereof. FIG. 16 illustrates an example computer system 1600 in which the contemplated embodiments, or portions thereof, can be implemented as computer-readable code. For example, the methods illustrated by flowcharts described herein can be implemented in system 1600. Various embodiments are described in terms of this example computer system 1600. After reading this description, it will become apparent to a person skilled in the relevant art how to implement the embodiments using other computer systems and/or computer architectures.

Computer system 1600 includes one or more processors, such as processor 1610. Processor 1610 can be a special purpose or a general purpose processor. Processor 151 0 is connected to a communication infrastructure 1620 (for example, a bus or network). Processor 1610 may include a CPU, a Graphics Processing Unit (GPU), an Accelerated Processing Unit (APU), a Field-Programmable Gate Array (FPGA), Digital Signal Processing (DSP), or other similar general purpose or specialized processing units.

Computer system 1600 also includes a main memory 1630, and may also include a secondary memory 1640. Main memory may be a volatile memory or non-volatile memory, and divided into channels. Secondary memory 1640 may include, for example, non-volatile memory such as a hard disk drive 1650, a removable storage drive 1660, and/or a memory stick. Removable storage drive 1660 may comprise a floppy disk drive, a magnetic tape drive, an optical disk drive, a flash memory, or the like. The removable storage drive 1660 reads from and/or writes to a removable storage unit 1670 in a well-known manner. Removable storage unit 1670 may comprise a floppy disk, magnetic tape, optical disk, etc. which is read by and written to by removable storage drive 1660. As will be appreciated by persons skilled in the relevant art(s), removable storage unit 1670 includes a computer usable storage medium having stored therein computer software and/or data.

In alternative implementations, secondary memory 1640 may include other similar means for allowing computer programs or other instructions to be loaded into computer system 1600. Such means may include, for example, a removable storage unit 1670 and an interface (not shown). Examples of such means may include a program cartridge and cartridge interface (such as that found in video game devices), a removable memory chip (such as an EPROM, or PROM) and associated socket, and other removable storage units 1670 and interfaces which allow software and data to be transferred from the removable storage unit 1670 to computer system 1600.

Computer system 1600 may also include a memory controller 1675. Memory controller 1675 includes functionalities to control data access to main memory 1630 and secondary memory 1640. In some embodiments, memory controller 1675 may be external to processor 510, as shown in FIG. 16. In other embodiments, memory controller 1675 may also be directly part of processor 1610. For example, many AMD™ and Intel™ processors use integrated memory controllers that are part of the same chip as processor 1610 (not shown in FIG. 16).

Computer system 1600 may also include a communications and network interface 1680. Communication and network interface 1680 allows software and data to be transferred between computer system 1600 and external devices. Communications and network interface 1680 may include a modem, a communications port, a PCMCIA slot and card, or the like. Software and data transferred via communications and network interface 1680 are in the form of signals which may be electronic, electromagnetic, optical, or other signals capable of being received by communication and network interface 1680. These signals are provided to communication and network interface 1680 via a communication path 1685. Communication path 1685 carries signals and may be implemented using wire or cable, fiber optics, a phone line, a cellular phone link, an RF link or other communications channels.

The communication and network interface 1680 allows the computer system 1600 to communicate over communication networks or mediums such as LANs, WANs the Internet, etc. The communication and network interface 1680 may interface with remote sites or networks via wired or wireless connections.

In this document, the terms “computer program medium,” “computer-usable medium” and “non-transitory medium” are used to generally refer to tangible media such as removable storage unit 1670, removable storage drive 1660, and a hard disk installed in hard disk drive 1650. Signals carried over communication path 1685 can also embody the logic described herein. Computer program medium and computer usable medium can also refer to memories, such as main memory 1630 and secondary memory 1640, which can be memory semiconductors (e.g. DRAMs, etc.). These computer program products are means for providing software to computer system 1600.

Computer programs (also called computer control logic) are stored in main memory 1630 and/or secondary memory 1640. Computer programs may also be received via communication and network interface 1680. Such computer programs, when executed, enable computer system 1600 to implement embodiments as discussed herein. In particular, the computer programs, when executed, enable processor 1610 to implement the disclosed processes, such as the steps in the methods illustrated by flowcharts discussed above. Accordingly, such computer programs represent controllers of the computer system 1600. Where the embodiments are implemented using software, the software may be stored in a computer program product and loaded into computer system 1600 using removable storage drive 1660, interfaces, hard drive 1650 or communication and network interface 1680, for example.

The computer system 1600 may also include input/output/display devices 1690, such as keyboards, monitors, pointing devices, touchscreens, etc.

It should be noted that the simulation, synthesis and/or manufacture of various embodiments may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a core that is embodied in program code and can be transformed to hardware as part of the production of integrated circuits.

The embodiments are also directed to computer program products comprising software stored on any computer-usable medium. Such software, when executed in one or more data processing devices, causes a data processing device(s) to operate as described herein or, as noted above, allows for the synthesis and/or manufacture of electronic devices (e.g., ASICs, or processors) to perform embodiments described herein. Embodiments employ any computer-usable or -readable medium, and any computer-usable or -readable storage medium known now or in the future. Examples of computer-usable or computer-readable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage devices, etc.), and communication mediums (e.g., wired and wireless communications networks, local area networks, wide area networks, intranets, etc.). Computer-usable or computer-readable mediums can include any form of transitory (which include signals) or non-transitory media (which exclude signals). Non-transitory media comprise, by way of non-limiting example, the aforementioned physical storage devices (e.g., primary and secondary storage devices).

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A computer-implemented method for enabling a user to configure energy management of at least one building or project from a remote computing device through an energy management service hosted on a computer network, comprising:
hosting a set of energy management modules configurable for different users subscribed to the energy management service;
storing in a database, coupled to the computer network, energy management information relating to a building or project fitted with wireless sensors that capture data representative of real-time power consumption;
receiving a request from a remote user to access the energy management service;
determining one or more of the energy management modules in the set in accordance with a subscriber profile associated with the remote user; and
enabling the remote user to access energy management information relating to a building or project from the remote computing device through the energy management service hosted on the computer network using the determined one or more energy management modules.

2. The method of claim 1, wherein the determined one or more energy management modules includes at least one of a building optimization module, portfolio benchmarking module, project tracking module, compliance module, or tenant billing module.

3. The method of claim 1, wherein the determined one or more energy management modules includes a building optimization module having a real-time energy optimization tool, and wherein the enabling includes providing the real-time energy optimization tool for display to the remote user on the remote computing device.

4. The method of claim 3, wherein the real-time optimization tool is configured to provide a graphical display of real-time power usage over a predetermined time period for the building based on the stored energy management information in the database.

5. The method of claim 4, wherein the graphical display of real-time power usage over a predetermined time period for the building comprises a candlestick graph that illustrates points of peak energy consumption along with regions of maximum and minimum consumption.

6. The method of claim 4, wherein the real-time optimization tool is configured to provide a user-interface element for a user to enter annotations.

7. The method of claim 4, wherein the real-time optimization tool is configured to provide a graphical display of statistical data on energy usage by the building based on the stored energy management information in the database.

8. The method of claim 4, wherein the real-time optimization tool is configured to provide a user-interface element that enables the remote user to select management, technical, scheduling, weather, or trend operations.

9. The method of claim 4, wherein the real-time optimization tool is configured to provide a user-interface element that enables the remote user to select a scheduling operation that enables the remote user to view energy usage over a selected time period by different building components.

10. The method of claim 1, wherein the determined one or more energy management modules includes a portfolio benchmarking module, and wherein the enabling includes providing a real-time energy optimization tool configured to provide a user interface element that allows the remote user at the remote computing device to obtain real-time portfolio status and performance information on the energy usage of a portfolio of buildings.

11. The method of claim 1, wherein the determined one or more energy management modules includes a compliance benchmarking module, and wherein the enabling includes providing a real-time energy optimization tool configured to provide a user interface element that allows the remote user at the remote computing device to automatically generate a compliance submission for a building.

12. The method of claim 11, wherein the real-time energy optimization tool is configured to provide a user interface element that allows the remote user at the remote computing device to view and track an energy rating and metrics for a building.

13. The method of claim 1, further comprising:
enabling the remote user to select one or more energy management modules for a subscription service;
enabling the remote user to identify a number of buildings or projects fitted with the wireless sensors that correspond to meters and sub-meters to be included in the subscription service; and
creating a subscriber profile for the remote user corresponding to the selected subscription service.

14. The method of claim 1, wherein the wireless sensors are interconnected in a wireless mesh network.

15. The method of claim 1, wherein the storing comprises:
storing in the database the energy management information in a relational data structure that represents electrical infrastructure of the building.

16. The method of claim 15, wherein the determined one or more energy management modules includes a property information management module configured to perform operations of:
displaying the energy management information organized in a hierarchy corresponding to the relational data structure.

17. The method of 16, wherein the relational data structure comprises a channel object associated with a meter object, and the storing comprises:
receiving data representative of real-time power consumption captured by one of the wireless sensors;
parsing the data to extract channel information;
identifying the channel object based on the extracted channel information;
processing the data to generate the energy management information; and
storing the energy management information in the relational data structure as being associated with the channel object in the relational data structure.

18. The method of claim 17, wherein the relational data structure further comprises:
a user account object representing an account of the user;
a property object associated with the user account object;
a building object associated with the property object, wherein the building object is associated with the meter object, a space object, a source object, and a component object;
an input object associated with the source object;
an input-to-channel association link that associates the input object with the channel object;
a component-to-input association link that associates the component object with the input object; and
a space-to-component association link that associates the space object with the component object.

19. The method of claim 18, further comprising:
retrieving the energy management information from the relational data structure in the database; and
using the relational data structure to identify the account object, the property object, the building object, the space object, the meter object, the source object, and the component object based on the energy management information; and
wherein the displaying comprises displaying the energy information with respective descriptive information stored in the account object, the property object, the building object, the space object, the meter object, the source object, and the component object in the hierarchy corresponding to the relational data structure.

20. The method of claim 19, wherein the using the relational data structure comprises:
identifying the channel object associated with the retrieved energy management information;
identifying the meter object associated with the channel object;
identifying the building object associated with the meter object;
identifying the property object associated with the building object;
identifying the account object associated with the property object;
identifying the input object associated with the channel object using the input-to-channel association link;
identifying the source object associated with the input object;
identifying the component object associated with the input object using the component-to-input association link; and
identifying the space object associated with the component object using the space-to-component association link.

21. A system for enabling a user to configure energy management of at least one building or project from a remote computing device through an energy management service hosted on a computer network, comprising:
a subscription manager implemented on a host computing device that hosts a set of energy management modules configurable for different users subscribed to the energy management service; and
a database, coupled to the host computing device, that stores energy management information relating to a building or project fitted with wireless sensors that capture data representative of real-time power consumption,
wherein the subscription manager is configured to:
receive a request from a remote user to access the energy management service;
determine one or more of the energy management modules in the set in accordance with a subscriber profile associated with the remote user; and
enable the remote user to access energy management information relating to a building or project from the remote computing device through the energy management service hosted on the computer network using the determined one or more energy management modules.

22. A non-transitory computer-readable medium, having instructions stored thereon, that when executed by at least one processor, cause the at least one processor to perform operations for enabling a user to configure energy management of at least one building or project from a remote computing device through an energy management service hosted on a computer network, comprising:
hosting a set of energy management modules configurable for different users subscribed to the energy management service;
accessing a database having stored energy management information relating to a building or project fitted with wireless sensors that capture data representative of real-time power consumption;
receiving a request from a remote user to access the energy management service;
determining one or more of the energy management modules in the set in accordance with a subscriber profile associated with the remote user; and
enabling the remote user to access energy management information relating to a building or project from the remote computing device through the energy management service hosted on the computer network using the determined one or more energy management modules.
